(19) United States
(12) Patent Application Publication
(10) Pub. No.: US 2014/0033322 A1
(43) Pub. Date: Jan. 30, 2014

(54) METHOD AND APPARATUS FOR MAPPING

(71) Applicants: Sunil Nair, North Brunswick, NJ (US); Dinesh Sinha, North Brunswick, NJ (US); Shirish H. Phatak, Bedminster, NJ (US)

(72) Inventors: Sunil Nair, North Brunswick, NJ (US); Dinesh Sinha, North Brunswick, NJ (US); Shirish H. Phatak, Bedminster, NJ (US)

(21) Appl. No.: 13/561,152

(22) Filed: Jul. 30, 2012

(51) Int. Cl. G06F 21/24

(52) U.S. Cl. 726/27

(57) ABSTRACT

A mobile device including a mobile device computer memory, a mobile device computer processor, a mobile device computer display, a mobile device computer interactive device, and a mobile device transmitter/receiver; and a server computer including a server computer memory, and a server computer processor. The mobile device computer processor may be programmed to allow a user by use of the mobile device computer interactive device to store a plurality of data objects in the server computer memory via transmission by the mobile device transmitter/receiver to the server computer, wherein each of the plurality of data objects includes data concerning a geographic location, such that there are a plurality of geographic locations, one geographic location for each of the plurality of data objects. The computer server processor may be programmed to restrict access to information concerning each geographic location such that this information is not available to the general public.

### FIELD OF THE INVENTION

This invention relates to improved methods and apparatus concerning mapping services and techniques.

### BACKGROUND OF THE INVENTION

With the advent of mobile devices, such as smart phones, tablet computers, and mobile appliances like global positioning systems (GPS), the computation available to a consumer all the time is unprecedented. The easy network connectivity to internet all the time through a mix of technologies like 3G (third generation mobile telecommunications)/4G (fourth generation mobile telecommunications) network, wireless, etc. help a mobile device always be connected to rest of the world. Additionally, mobile devices now have sensors like GPS and accelerometer and connectivity through Bluetooth or GSM (global system for mobile communications), making it very easy to locate mobile devices.

Mapping services have been available for a while, such as Mapquest (trademarked), Google (trademarked) maps, Bing (trademarked), and Yahoo (trademarked). Now these services allow the points in these maps to be augmented by user data (private points). So a private point will be points shown in the map only to this user or to users subscribed to a private add-on on top of the particular mapping service. Additionally some mapping services also provide the ability to configure/add public points available to all the users.

These mapping services are particularly useful for mobile devices where they can be dynamically updated depending on the location of the mobile device. For example GPS computer software displaying best path and traffic on a map, or a business listing service showing the five nearest restaurants to the mobile device on a map.

### SUMMARY OF THE INVENTION

One or more embodiments of the present invention, provide a mobile device computer software application, which may be called “iBrush” that helps users to easily add/manage private or shared geographic points to a database so that it can be easily viewed on a mobile device computer display in a textual listing, map based view, augmented reality view, audio only or by a third party application. The computer software application, in at least one embodiment can use any third party service to display its geographic points on a mobile device e.g. Google (trademarked) map, Layar (trademarked), Wikitude (trademarked) etc (wherein the third party service is referred as a Rendering Platform). One or more embodiments of the present invention provide a computer software application that has a flexible framework that lets it be used easily in different applications like museum mapping, theme park mapping, instant coupons, smart business cards, etc. These applications will be described later.

A Rendering Platform is a platform like Layar (trademarked) or Google (trademarked) maps or a propriety mobile application or web based application that is responsible for displaying the relevant points. In at least one embodiment of the present invention a rendering platform accesses the ibServer or ibContextServer to display results on a mobile device computer display.

Renderer Browser is part of Renderer Platform that resides on mobile device as a mobile computer software application. The render browser is responsible for displaying results to the mobile device user on the mobile device computer display.

In at least one embodiment of the present invention, an apparatus is provided comprising a mobile device which may include a mobile device computer memory, a mobile device computer processor, a mobile device computer display, a mobile device computer interactive device, and a mobile device transmitter/receiver. The apparatus may also include a server computer comprising a server computer memory, and a server computer processor. The mobile device computer processor may be programmed by a computer program stored in the mobile device computer memory to allow a user by use of the mobile device computer interactive device to store a plurality of data objects in the server computer memory via transmission by the mobile device transmitter/receiver to the server computer, wherein each of the plurality of data objects includes data concerning a geographic location, such that there are a plurality of geographic locations, one geographic location for each of the plurality of data objects. Each geographic location of the plurality of geographic locations may be shared by a plurality of users.

The mobile device computer processor may be programmed by a computer program stored in the mobile device computer memory to allow a user to cause information concerning each geographic location of each of the plurality of data objects to be retrieved from the server computer memory via the mobile device transmitter/receiver and to be displayed on the mobile device computer display computer software program. The computer server processor may be programmed by a computer program stored in the server computer memory to restrict access to information concerning each geographic location of each of the plurality of data objects such that this information is not available to the general public.

The computer server processor may restrict access to information concerning each geographic location to a one or more users who created the information concerning the geographic location. The mobile device computer processor may be programmed by a computer program stored in the mobile device computer memory so that selecting the information for each geographic location causes defined actions to be executed by the mobile device computer processor for each geographic location, wherein instructions for the defined actions are stored as a computer program in the mobile device computer memory.

The mobile device computer processor may be programmed to set an indication of whether information concerning each geographic location is active, wherein when active, a user, permitted access to the information concerning each geographic location is allowed to view the information concerning each geographic location on the mobile device computer display. The information concerning each geographic location may relate to a location at which the mobile device is at least at one time located. The information concerning each geographic location may be retrieved from a public internet search service and then stored in the server computer memory. The information concerning each geographic location may be supplied by a third party computer software application.

The server computer memory may include first and second application programming interface computer software programs which are executed by the server computer processor. The first application programming interface computer software program may be programmed to be executed by the server computer processor in response to a communication with the mobile device computer processor concerning storing of the plurality of data objects in the server computer memory. The second application programming interface computer software program may be programmed to be executed by the server computer processor in response to a communication with the mobile device computer processor concerning retrieval of information concerning each geographic location from the server computer memory via the mobile device transmitter/receiver and display of information concerning each geographic location on the mobile device computer display.

The server computer processor may be programmed to alter a listing of geographical points stored in the server computer memory in response to a request from the mobile device computer processor. Each geographic location of each of the plurality of data objects may be defined by coordinates.

In at least one embodiment of the present invention a method is provided which may include using a mobile device computer processor to store a plurality of data objects in a server computer memory via transmission by a mobile device transmitter/receiver to the server computer, wherein each of the plurality of data objects includes data concerning a geographic location, such that there are a plurality of geographic locations, one geographic location for each of the plurality of data objects; using the mobile device computer processor to retrieve each geographic location of each of the plurality of data objects from the server computer memory via the mobile device transmitter/receiver and to display each geographic location of each of the plurality of data objects on a mobile device computer display through a window of a computer software program; and wherein the computer server processor restricts access to information concerning each geographic location of each of the plurality of data objects. The method may be implemented by one or more computer processors programmed to execute one or more of the functions previously described with regards to the features of an apparatus in accordance with one or more embodiments of the present invention.

### BRIEF DESCRIPTION OF THE DRAWINGS

FIG. 1A shows a block diagram for a mobile device in accordance with an embodiment of the present invention;

FIG. 1B shows a block diagram for a server computer in accordance with an embodiment of the present invention;

FIG. 2 shows a block diagram demonstrating the flow of data from modules of the mobile device computer processor of FIG. 1A to modules of a server computer processor of FIG. 1B;

FIG. 3 shows a block diagram showing data linked in a database of a server computer memory of FIG. 1B;

FIG. 4 shows a block diagram showing data levels in a database of the server computer memory of FIG. 1B;

FIG. 5 shows a flow chart of recording process tasks executed by the mobile device computer processor and/or the server computer processor as programmed by computer software stored in a mobile device computer memory of FIG. 1A and/or the server computer memory of FIG. 1B;

FIG. 6 shows a flow chart of a manual recording process executed the mobile device computer processor and/or the server computer processor as programmed by computer software stored in the mobile device computer memory and/or the server computer memory;

FIG. 7 shows a flow chart of a listing recording process executed the mobile device computer processor and/or the server computer processor as programmed by computer software stored in the mobile device computer memory and/or the server computer memory;

FIG. 8 shows a flow chart of an Address book recording process executed the mobile device computer processor and/or the server computer processor as programmed by computer software stored in the mobile device computer memory and/or the server computer memory;

FIG. 9 shows a flow chart of a prefill IbPoint and Actions process executed the mobile device computer processor and/or the server computer processor as programmed by computer software stored in the mobile device computer memory and/or the server computer memory;

FIG. 10 shows a flow chart of a find list of contexts for a user process executed the mobile device computer processor and/or the server computer processor as programmed by computer software stored in the mobile device computer memory and/or the server computer memory;

FIG. 11 shows a flow chart of a find if a ibContext is active process executed the mobile device computer processor and/or the server computer processor as programmed by computer software stored in the mobile device computer memory and/or the server computer memory;

FIG. 12 shows a flow chart of a find if ibPoint is available process executed the mobile device computer processor and/or the server computer processor as programmed by computer software stored in the mobile device computer memory and/or the server computer memory;

FIG. 13 shows a flow chart of a geo filter for each ibPoint process executed the mobile device computer processor and/or the server computer processor as programmed by computer software stored in the mobile device computer memory and/or the server computer memory;

FIG. 14 shows a flow chart of a visual filter for each IbPoint process executed the mobile device computer processor and/or the server computer processor as programmed by computer software stored in the mobile device computer memory and/or the server computer memory;

FIG. 15 shows a flow chart of an application filter for each IbPoint process executed the mobile device computer processor and/or the server computer processor as programmed by computer software stored in the mobile device computer memory and/or the server computer memory;

FIG. 16 shows a flow chart of an application filter locator for each IbPoint process executed the mobile device computer processor and/or the server computer processor as programmed by computer software stored in the mobile device computer memory and/or the server computer memory;

FIG. 17 shows a flow chart of a render process executed the mobile device computer processor and/or the server computer processor as programmed by computer software stored in the mobile device computer memory and/or the server computer memory;

FIG. 18 shows a flow chart of a map view process executed the mobile device computer processor and/or the server computer processor as programmed by computer software stored in the mobile device computer memory and/or the server computer memory;

FIG. 19 shows a flow chart of augmented reality view process executed the mobile device computer processor and/or the server computer processor as programmed by computer software stored in the mobile device computer memory and/or the server computer memory;

FIG. 20 shows a flow chart of audiorreality view process executed the mobile device computer processor and/or the server computer processor as programmed by computer software stored in the mobile device computer memory and/or the server computer memory;

FIG. 21 shows a flow chart of augmented locator view process executed the mobile device computer processor and/or the server computer processor as programmed by computer software stored in the mobile device computer memory and/or the server computer memory;

FIG. 22 shows a flow chart of an application view process executed the mobile device computer processor and/or the server computer processor as programmed by computer software stored in the mobile device computer memory and/or the server computer memory;

FIG. 23 shows a flow chart of an ibActions process executed the mobile device computer processor and/or the server computer processor as programmed by computer software stored in the mobile device computer memory and/or the server computer memory;

FIG. 24 shows a flow chart of an Application based ibActions process executed the mobile device computer processor and/or the server computer processor as programmed by computer software stored in the mobile device computer memory and/or the server computer memory;

FIG. 25 shows a flow chart of an Augmented VC process executed the mobile device computer processor and/or the server computer processor as programmed by computer software stored in the mobile device computer memory and/or the server computer memory;

FIG. 26 shows a flow chart of an Augmented VC process executed the mobile device computer processor and/or the server computer processor as programmed by computer software stored in the mobile device computer memory and/or the server computer memory;

FIG. 27 shows a first image which the mobile device computer processor and/or the server computer processor may cause to appear on the mobile device computer display of FIG. 1A;

FIG. 28 shows a second image which the mobile device computer processor and/or the server computer processor may cause to appear on the mobile device computer display of FIG. 1A;

FIG. 29 shows a third image which the mobile device computer processor and/or the server computer processor may cause to appear on the mobile device computer display of FIG. 1A;

FIG. 30 shows a fourth image which the mobile device computer processor and/or the server computer processor may cause to appear on the mobile device computer display of FIG. 1A; and

FIG. 31 shows a fifth image which the mobile device computer processor and/or the server computer processor may cause to appear on the mobile device computer display of FIG. 1A.

### DETAILED DESCRIPTION OF THE DRAWINGS

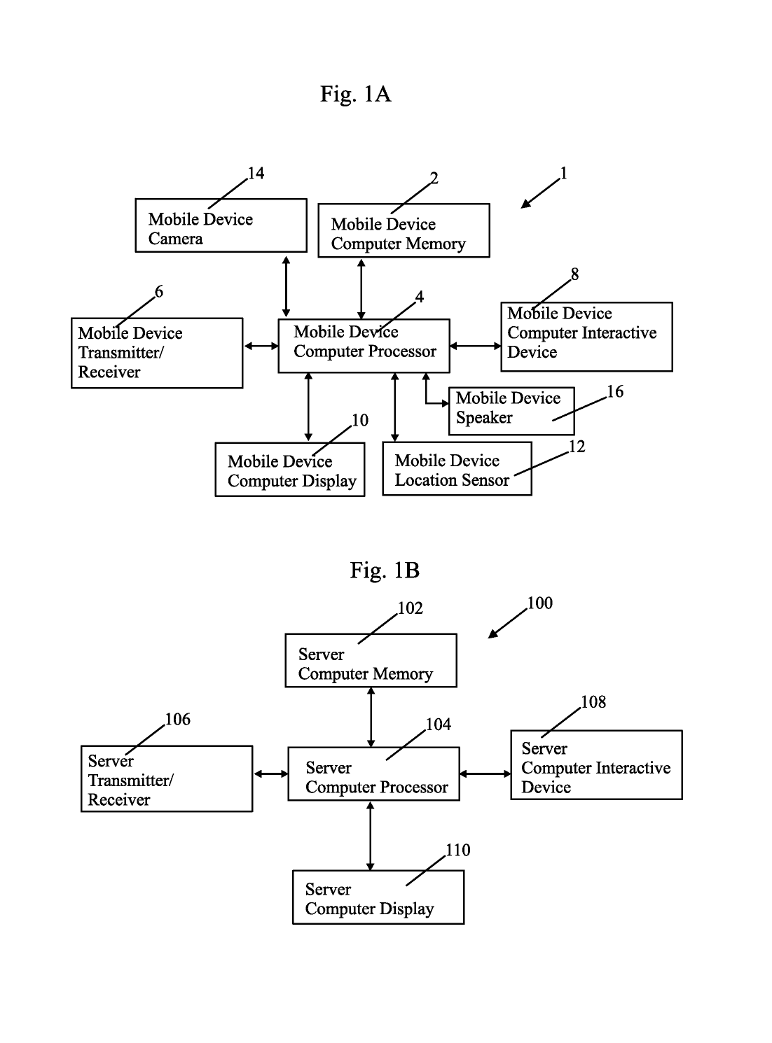

Generally speaking, FIGS. 1A-4 provide high level concept description or one or more embodiments of the present invention.

FIG. 1A shows a block diagram for a mobile device 1 in accordance with an embodiment of the present invention. The mobile device 1 includes mobile device computer memory 2, mobile device computer processor 4, mobile device transmitter/receiver 6, mobile device computer interactive device 8, mobile device computer display 10, a mobile device location sensor 12, and a mobile device camera 14. The mobile device computer memory 2, the mobile device transmitter/receiver 6, the mobile device computer interactive device 8, the mobile device computer display 10, and the mobile device location sensor 12 may be connected by any known communications links to the mobile device computer processor, such as hardwired, wireless, optical or any other communications links. The mobile device computer interactive device 8 include one or more of a computer mouse, computer keyboard, computer touchscreen or other user input device.

FIG. 1B shows a block diagram for a server computer 100 in accordance with an embodiment of the present invention. The server computer 100 includes server computer memory 102, server computer processor 104, server computer transmitter/receiver 106, server computer interactive device 108, and server computer display 110. The server computer memory 102, the server computer transmitter/receiver 106, the server computer interactive device 108, and the server computer display 110 may be connected by any known communications links to the server computer processor, such as hardwired, wireless, optical or any other communications links.

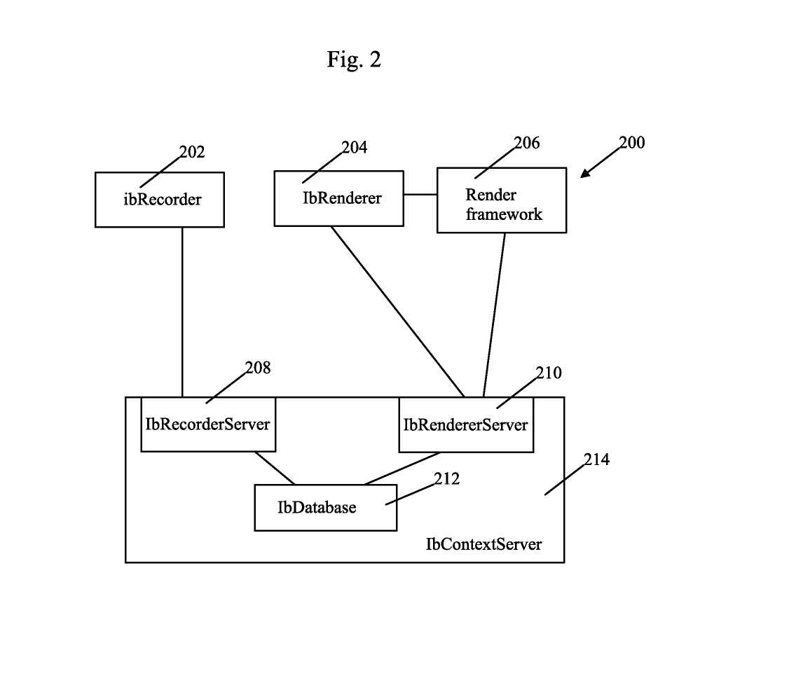

FIG. 2 shows a block diagram demonstrating the flow of data from modules of the mobile device computer processor 4 of FIG. 1A to modules of a server computer processor 104 of FIG. 1B. The server computer memory 102 and/or the server computer processor 104 may include a server computer called “IbContextServer” or server computer 214 which is shown in FIG. 2. The “IbContextServer” or server computer 214 may include an “IbRecorderServer” or server computer 208, and “IbRendererServer” or server computer 210, and an IbDatabase 212 which may be part of server computer memory 102 of FIG. 1B. The “IbContextServer” or server computer 214 is in communication by communication links with “IbRecorder” 202, “IbRenderer” 204, and “Render framework” 206. The IbRecorder 202, the IbRenderer 204, and the Render framework 206 may be computer software modules stored in mobile device computer processor 4 of FIG. 1A which can communicate with the server computer processor 104 or server computer 214 within the server computer processor 104, via mobile device transmitter/receiver 6 and server transmitter/receiver 106.

The Ib Context Server computer 214 resides as a web service accessible to mobile devices, such as mobile device 1 of FIG. 1A, through a computer software application called “iBrush App” or a computer software application called “RendererFramework” which may reside on the mobile device computer memory 2. The IbContextServer or server computer 214 may include the ibRecorderServer or server computer 208 and the ibRendererServer or server computer 210. Both server computer 208 and server computer 210 are accessible as an internet or web service by the mobile device 1 or more specifically via representational state transfer (REST) based requests from the mobile device 1 to the server computer 100, via the transmitter/receiver 6 and the transmitter/receiver 106. The results from the server computer 100 are returned to the mobile device 1, via transmitter/receivers 6 and 106, as JSON (JavaScript Object Notation) objects.

The mobile device 1 includes an iBrush computer software application program or module, which may be stored in the mobile device computer memory 2 that may include ibRecorder computer software module 202 and ibRenderer computer software module 204. The ibRenderer computer software module may include an embedded RendererBrowser.

The reason why we have Renderer Framework or RendererBrowser 206 in FIG. 2 different from ibRenderer 204 is that ibRenderer 204 controls how the user sees the view on mobile device computer display 10 using one of the many Renderer Framework or RendererBrowser 206. The RendererBrowser or Renderer Framework 206 may include a list or table display, on the mobile device computer display 10, of all the IBPoints available currently. The RendererBrowser or Framework 206 may include a voice based prompt, which may be input through the mobile device computer interactive device 8, which may include a speech input or speech recognition device. The RendererBrowser or Framework 206 may include a computer program which uses another browser computer software program such as a Mapping service like Google (trademarked). Alternatively, the RendererBrowser may include a Wikitude (trademarked)/Layar (trademarked) like augmented reality. So in summary, ibRenderer 204 may control multiple Renderer Browsers or Frameworks similar or identical to 206.

In at least one embodiment, the computer software module IbRecorder 202 of the mobile device 1 communicates to the ibContextServer 214 of the server computer 100, via transmitter/receivers 6 and 106 using an API (application programming interface) of the IbRecorder Server 208, such as an application programming interface known in the art. Similarly, the ibRenderer computer software module 204 of the mobile device 1 may communicate with the IbRenderer Server or server computer 210 using an ibRendererServer application programming interface, such as an application programming interface known in the art. These requests are satisfied by using ibDatabase 212 which may be a database which is part of the server computer memory 102 of FIG. 1B. IbDatabase 212 may exist on the same server computer as IbRendererServer 210 or a different one. For best results IbDatabase 212 should be on the same server computer as IbRenderer server 210. In at least one embodiment, ibRenderer 204 on the mobile device 1 may not communicate directly with ibRendererServer 210 but rather may communicate with ibRendererServer 210 through Render framework 206 of the mobile device 1. The render framework 206, in at least one embodiment, may not be on the mobile device 1, but rather may be an intermediate module located on another server computer. In at least one embodiment, a part of ibRenderer 204 may reside on the mobile device 1, and this part may be called the RendererBrowser. In such a case the other part of ibRenderer 204 may reside on ibContextServer 214 or on another server computer.

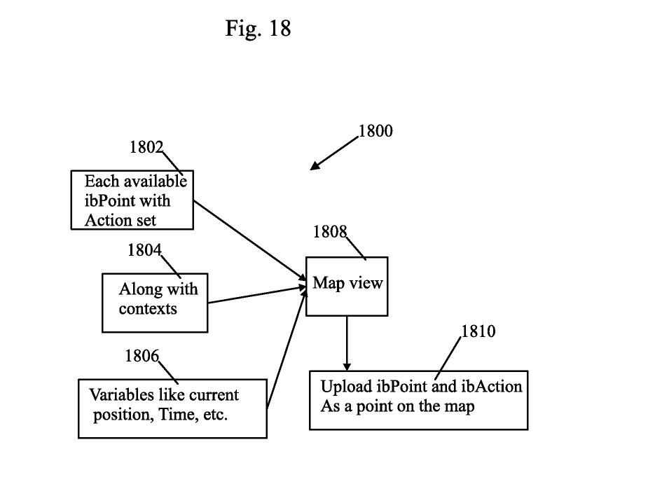

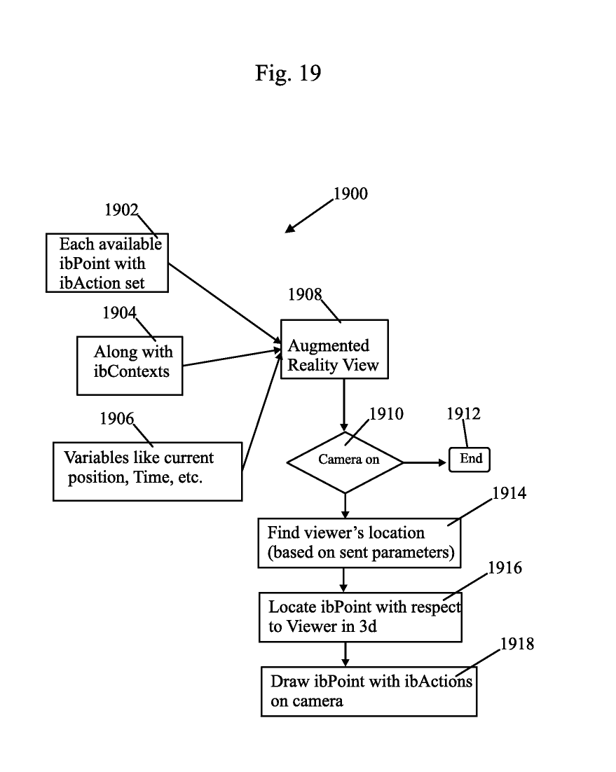

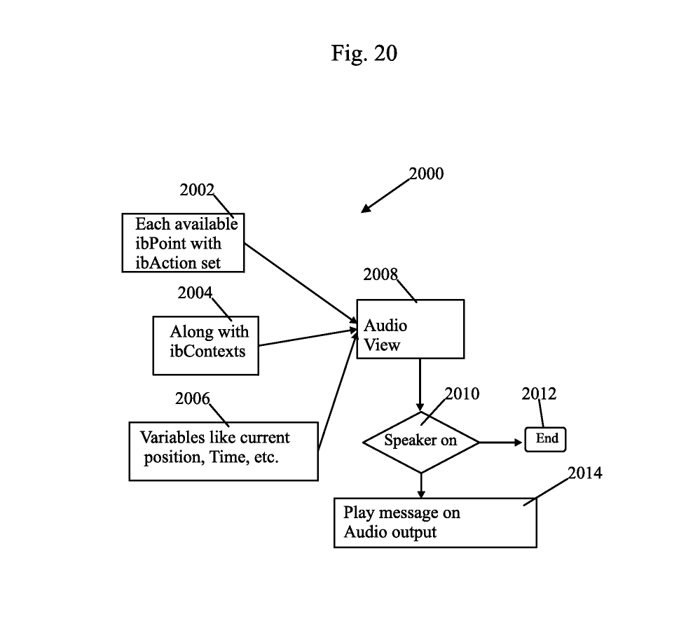

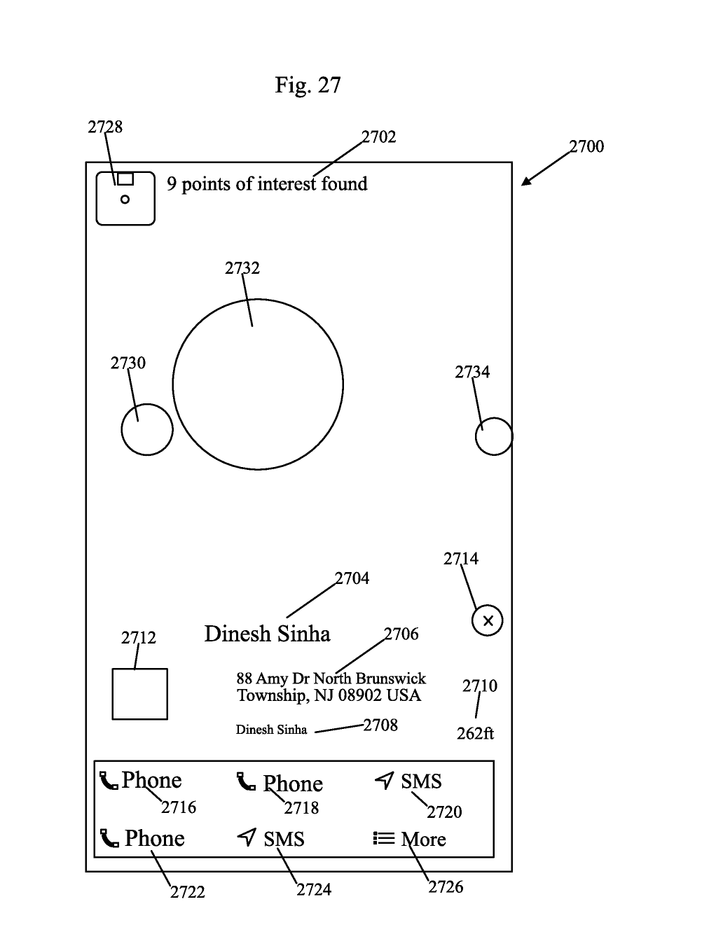

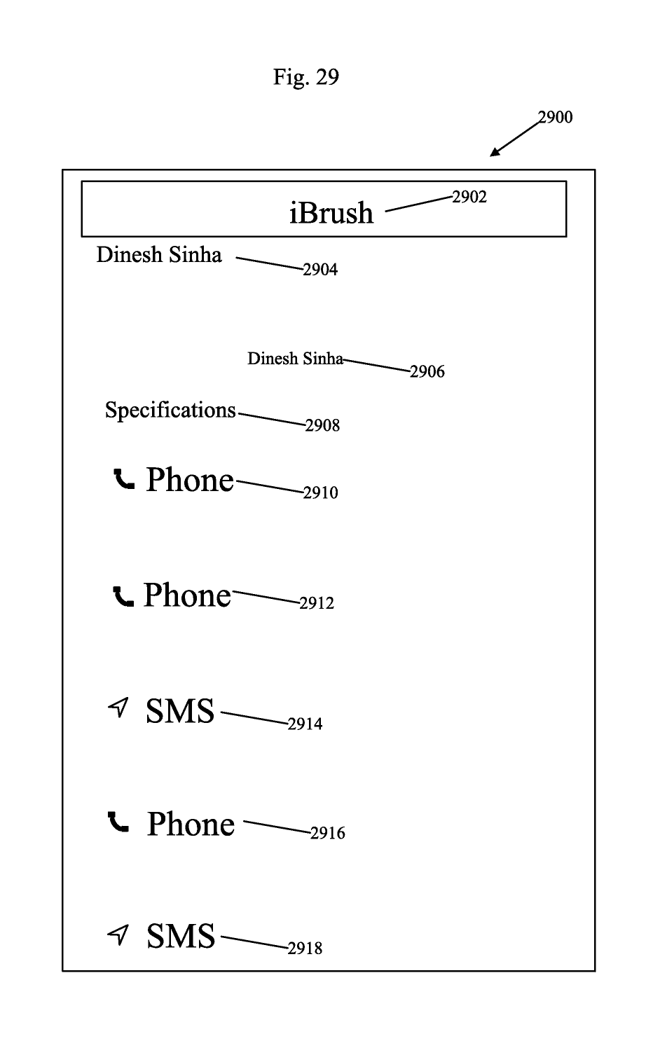

In at least one embodiment, the mobile device 1 may include the IbRecorder computer software module 202, and the IbRenderer software module 204. The IbRecorder computer software module 202 is executed by the mobile device computer processor 4 to cause recording and/or storing of geographic data points and/or data defining or related to geographic data points to the ibDatabase 212 of server computer memory 102 of the server computer 100, via transmitter/receivers 6 and 106. The geographic data points or data defining or related to geographic data points, after recording on server computer memory 102, are accessible via the IbRenderer computer software module 204 stored on mobile device computer memory 2 and executed by mobile device computer processor 4, and via transmitter/receivers 6 and 106. The IbRenderer computer software module 204 may be executed by the mobile device computer processor 4 such as by input (via computer keyboard, mouse, or touchscreen) through mobile device computer interactive device 8 to display these geographic points and/or information related to these geographic data points on the mobile device computer display 10 of the mobile device 1 depending on the context. The geographical points and/or information related to the geographical data points can be displayed in various ways on the mobile device computer display 10 such as textual listing (such as for example as shown in FIG. 29. where the user is able to view his private IBPoints coming from private IBContexts or public points coming from shared IBContexts.), map based (described in FIG. 18), augmented reality (described in FIG. 19 and example shown in FIG. 27), and audio (described in FIG. 20). The geographical data points or information related to the geographical data points may be pulled or accessed from ibDatabase 212 through ibContextServer 214 by the mobile device 1.

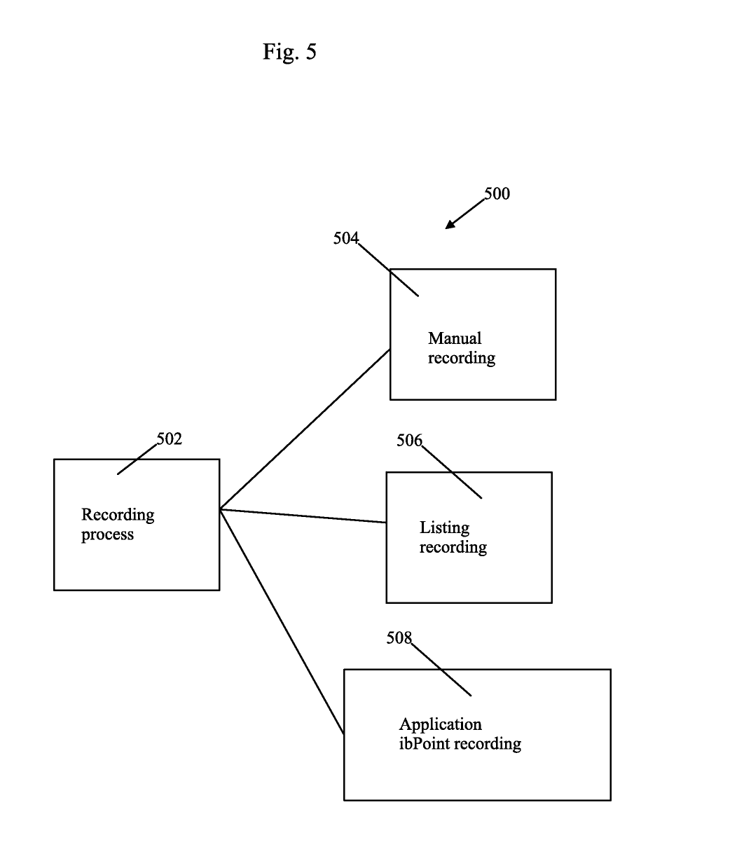

The ibContextServer 214 may be, or may include or execute a web based service available to mobile device 1 as well as a RenderingPlatform, such as a computer software program “ibRecorderAp1” which is described in FIGS. 5-9. The “ibRendererAp1” computer software program or aspects of it are shown in FIGS. 1-26. The ibContextServer 214 may have different at least two set of application programming interfaces (APIs)—ibRecorder API for requests or communications from ibRecorder module 202 of the mobile device 1 and ibRenderer API for requests or communications from ibRenderer module 204 of the mobile device 1.

The ibRecorderServer 208 may be an application programming interface (API) to the ibContextServer 214 that manages geographic points, (such as by adding, deleting, adding and listing geographic points) from ibRecorder 202. The ibRecorderServer 208, in at least one embodiment, is available to the ibRecorder module 202 of the mobile device 1. On receiving a request from ibRecorder 202, the ibRecorderServer 208 manipulates the ibDatabase 212 and returns results back to the ibRecorder 202 on the mobile device 1, via the transmitter/receivers 6 and 106.

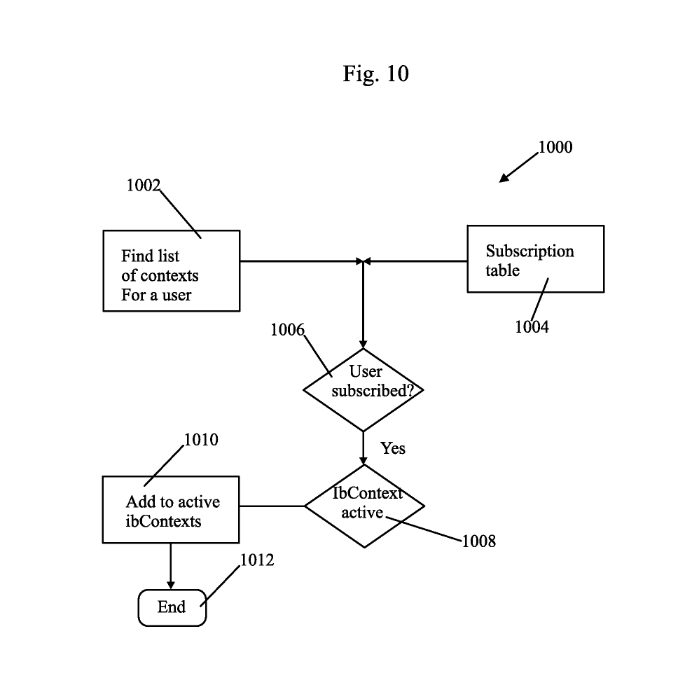

The ibRendererServer 210, in at least one embodiment is an application programming interface (API) accessed by a RenderingPlatform such as described in FIGS. 10-26. These APIs (208 and 210) access the ibDatabase 212 to return results to the RenderingPlatform which may be described in FIGS. 10-26.

The IbDatabase 212 is a store in server computer memory 102 for iBrush related data accessed by ibContextServer 214 or server computer processor 104 through ibRecorderServer API 208 or ibRendererServer API 210.

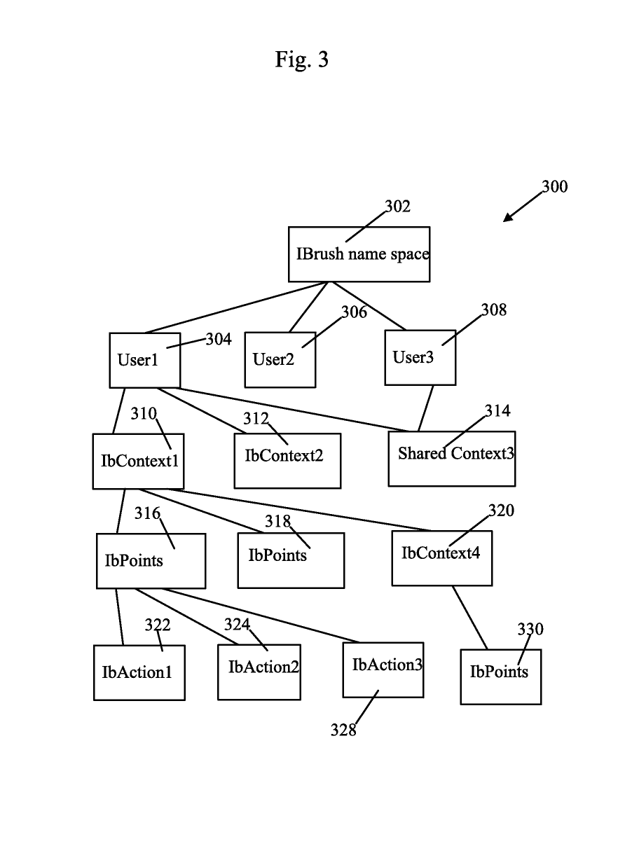

FIG. 3 shows a block diagram 300 showing data linked in a database of the server computer memory 102. The block diagram 300 shows data objects iBrushname space 302, user1 304, user2 306, user3 308, IbContext1 310, IbContext2 312, Shared Context3 314, IbPoints 316, IbPoints 318, IbContext4 320, IbAction1 322, IbAction2 324, IbAction3 328, and IbPoints 330 which may be stored in server computer memory 102. The iBrushname space 302 data object is linked in the server computer memory 102 to the user1 304, user2 306, and user3 304 data objects. The user1 data object is linked to the IbContext1 310, IbContext2 312, and SharedContext3 314 data objects in the server computer memory 102. The user3 308 data object is linked to the Shared context3 314 data object in the server computer memory 102.

The IbContext1 310 data object is linked to the IbPoints 316, IbPoints 318, and IbContext4 320 data objects in the server computer memory 102. The IbPoints 316 data object is linked to the IbAction1 322, IbAction2 324, and the IbAction3 data objects in the server computer memory 102. The IbContext4 320 data object is linked to the IbPoints 330 data object in the server computer memory 102.

Each of data objects ibCuser1 310, IbContext2 312, and IbContext4 320 or a shared ibContext Shared Context3 314 in FIG. 3 is a collection of related points to be shown on a map. In at least one embodiment, the only difference between a private ibContext like ibContext 310 and a shared ibContext like Share Context3 314 is that a private ibContext is only available to the user who created. In at least one embodiment, shared ibContext is available to any user or to social media contacts (e.g. Facebook (trademarked) friends, Twitter (trademarked) followers or LinkedIn (trademarked) contacts). The social media contacts can import an ibContext for their use after the creator or publisher posts the ibContext as an URI on a common place e.g. Facebook (trademarked) wall, Twitter (trademarked) tweet or LinkedIn (trademarked) message, An example of the link would be something like http://www.geomarks.com/ibrush/import/sharedcontext1.

Actions can be performed on any one of the data objects 310, 312, 314 and 320 directly by the server computer processor 104 as programmed by computer software stored on the server computer memory 102. For example, the server computer processor 104 can be programmed to “activate” a context data object of 310, 312, 314 or 320 and in at least one embodiment, this will make it possible to view on the mobile device computer display 10 the points of the activated context of 310, 312, 314 or 320 using a RendererBrowser computer software module running on the mobile device computer processor 4 and/or stored on the mobile device computer memory 2. For example, the ibCuser1 310 may be a restaurant data object, specifying geographic points corresponding to a plurality of different restaurants. A user of the mobile device 1 might activate such a restaurant context for data object 310 when hungry. Similarly, the user may activate a theme park context for ibContext2 312 along with a restaurant context for ibCuser1 310, if he/she is also inside a theme park to access a real time map of a theme park along with restaurant list inside the theme park. Activating an ibContext data object, such as data object 310, in at least one embodiment, causes all the ibPoints, such as IbPoints 316, IbPoints 318, and IbPoints 330 corresponding to and/or linked to the particular IbContext data object, to be visible via a RendererBrowser computer software program stored on the mobile device computer memory 2 and visible on the mobile device computer display 10.

Each of the ibCuser1 310, ibContext2 312, and the ibContext4 320 data objects is a user specific data object stored in the server computer memory 102 or shared data object (e.g. Shared Context3 314) also stored in the server computer memory 102. For example, a user1 named “Harry” may have ibCuser1 310, ibContext2 312, and ibContext4 320 data objects which are stored in the server computer memory 102. Each ibContext of 310, 312, and 320, is a row of data in an IBContextTable in an ibDataBase (described in the table description), which may be stored in computer memory 2 and/or computer memory 102.

Every user is subscribed to a set of ibCuser1 310, ibContext2 312, and ibContext4 320 data objects available to him or her. Each of the ibCuser1 310, ibContext2 312, and the ibContext4 320 data objects for each user may be a context created by that user, a context that that user is subscribed to by virtue of membership to different groups or a fully public context. In at least one embodiment, ibCuser1 310, ibContext2 312, and IbContext4 320 of each user, has its set of ibPoints data objects or another ibContext data object. Letting an ibContext data object have another ibContext data object makes a context within a context possible. This way, it is possible to go from a generic set to a more specific set. Each of ibPoints data objects 316, 318, and 330 may have zero or more ibActions data objects defined on them, such as IbAction1 322, IbAction2 324, and IbAction 3 328 for IbPoints 316 shown in FIG. 3.

Each of IbPoints data objects 316, 318, and 320 include geographic points that are caused to be displayed on the mobile device computer display 10 by the mobile device computer processor 4 executing a Renderer Browser computer software program. Each of the data objects 316, 318, and 320 belong to or is linked in server computer memory 102 to a context of IbContext1 310, IbContext2 312, and IbContext4 320. In addition to being a geographical point marked on the mobile device computer display 10 by the RendererBrowser computer software program executed by the mobile device computer processor 4, clicking or selecting one of the objects IbPoints 316, 318, and 320 allows a set of actions on this point.

The ibAction1 322, IbAction2 324, and IbAction3 328 are actions allowed on an ibPoint (of 316, 318, 330) by use of RendererBrowser computer program running on the mobile device 1. For example, a restaurant ibPoint for IbPoint 316 will allow actions like calling a restaurant or looking at its online menu.

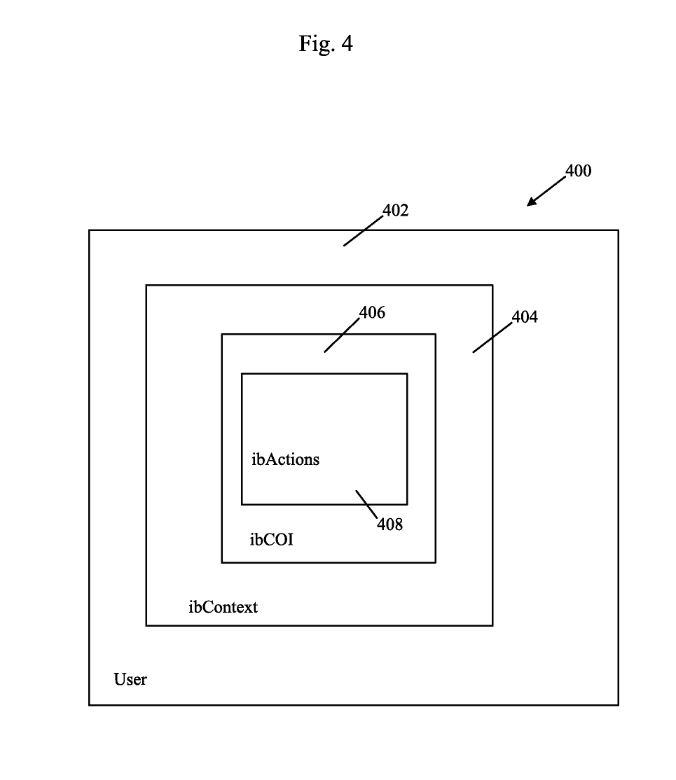

FIG. 4 shows a block diagram 400 showing data levels in a database of the server computer memory 102 of FIG. 1B. As shown by FIG. 4, an ibActions data object 408 (which may be one of 322, 324, and 328 shown in FIG. 3), lies within an ibCOI data object 406 (which may be one of 316, 318 and 330), which lies within an ibContext data object 404 (which may be one of IbContexts 310, 312, 314 and 320), which lies within a User data object 402 (which may be one of data objects 304, 306, and 308 shown in FIG. 3).

FIGS. 5-9 generally, mostly concern a computer software application called “ibRecorder Api” which may be stored in mobile device computer memory 2 and which may be executed by the mobile device computer processor 4, in accordance with one or more embodiments of the present invention. The high level purpose of the subject matter of FIGS. 5-9 is to record the variables “ibContext”, “ibPoint”, and its “ibActions” for each user as personal or shared data and store in ibDatabase which may be located in mobile device computer memory 2 and/or server computer memory 102.

FIG. 5 shows a flow chart 500 of recording process tasks executed by the mobile device computer processor 4 and/or the server computer processor 104 of FIG. 1B, as programmed by computer software stored in the mobile device computer memory 2 and/or the server computer memory 102 of FIG. 1B.

The ibRecorder module 202 as executed by the mobile device computer processor 4 is responsible for managing users, ibContexts, ibPoints and ibActions. Specifically for the case of ibPoints, there are at least three ways, in accordance with embodiments of the present invention, of recording IbPoints or geographic points in mobile device computer memory 2 and in server computer memory 102. The recording IbPoints process is referred to generally as recording process 502 in FIG. 5. The three ways are referred to as manual recording 504, listing recording 506, and application IbPoints recording 508.

(a) Manual recording 504. The computer processor 4 of the mobile device 1 may record a current geographic location as an ibPoint in a data object IbPoint or IbPoints, such as 316, in mobile device computer memory 2. The mobile device location sensor 12, which may be a global positioning system sensor (GPS), may determine or obtain the geographic coordinates of a current location of the mobile device 1, such as automatically, or in response to an input to the mobile device computer interactive device 8. Any description and detail regarding the current location of the mobile device 1 may be filled by the mobile user of the mobile device 1 through device 8 and this may be stored in mobile device computer memory 2 and server computer memory 102. In one or more embodiments description and detail regarding a particular geographic location may be pre-filled by doing a reverse lookup of address from geographic coordinates through existing internet services which makes this possible such as Google (trademarked) geo-coder.

(b) Listing recording 506. A second way in which geographic location points can be recorded in memory 2 or memory 102, is for the mobile user to make a textual query, via the mobile device 1, such as by entering the term “restaurants” in a search service or a modified search service, such as a modified version of Google (trademarked) via the mobile device computer interactive device 8. The user may limit the number of results returned to for example five results. By default the server computer processor 104 may be preconfigured to a number of results such as ten results. The computer software module ibRecorder 202 of the mobile device 1, sends a query to ibContextServer 214 via transmitter/receivers 6 and 106. In at least one embodiment, IbContextServer 214 makes a query to a public service e.g. Google (trademarked) lookup providing the search terms as well as the geographic coordinates of the mobile device 1. Based on that, the public service returns results to ibContextServer 214 or server computer 100, which returns the results back to ibRecorder 202 of the mobile device 1. The mobile device computer processor 4 causes the result to be displayed as a list on the mobile device computer display 10 of the mobile device 1 and on user confirmation, via an input through mobile device computer interactive device 8, added as an ibPoint data object to the computer memory 2 and the computer memory 102 in the same manner as above.

Alternatively, or additionally, the ibRecorder computer software module 202, executed by the computer processor 4 may make queries to a public service, such as Google (trademarked).

(c) Application IbPoint recording 508. A third way in which geographic location points can be recorded in memory 2 or memory 102 is via a third party computer software application which may be any mobile computer software application that is running on the mobile device 1, and which contains data records with physical addresses or picture representations of physical addresses e.g. phone book, social media contact list e.g. Facebook (trademarked) friends, Twitter (trademarked) followers or LinkedIn (trademarked) contacts. Let us say that the third party computer software application in this case is a phone book (contact list). Assume in one example that a user of the mobile device 1, makes a textual query e.g. by entering “732” into mobile device computer interactive device 8, with an intention to fill all contacts in the area code “732”. Most internet platforms (i.e. services, such as Google (trademarked), provide methods to make queries to these third party computer software applications (like address book). For example an Android (trademarked) platform has a well defined content provider method to make queries to an address book. Once the result is returned, for each record a query is made to ibRecorderServer 208 to fetch geographic coordinates from an address. Again, in similar manner as described above, ibRecorderServer 208 of server computer 100 calls a public service like Google (trademarked) geocoder to find the coordinates of this address. Once the results are available to ibContextServer 214 of server computer 100, the coordinates are returned back to ibRecorder 202 of the mobile device 1. The module IbRecorder 202 has all the information available to store this contact record as an ibPoint data object in computer memory 2 of mobile device 1 and in computer memory 102 of server computer 100 through transmitter/receivers 6 and 106. On user confirmation, the module IbRecorder 202, as executed by computer processor 4, proceeds to save the data as ibPoint in computer memory 2 or computer memory 102. Please note that it is also possible for ibRecorder module 202 to make queries to geocoders directly. By going through the ibContextServer 214, the results can be cached between multiple requests.

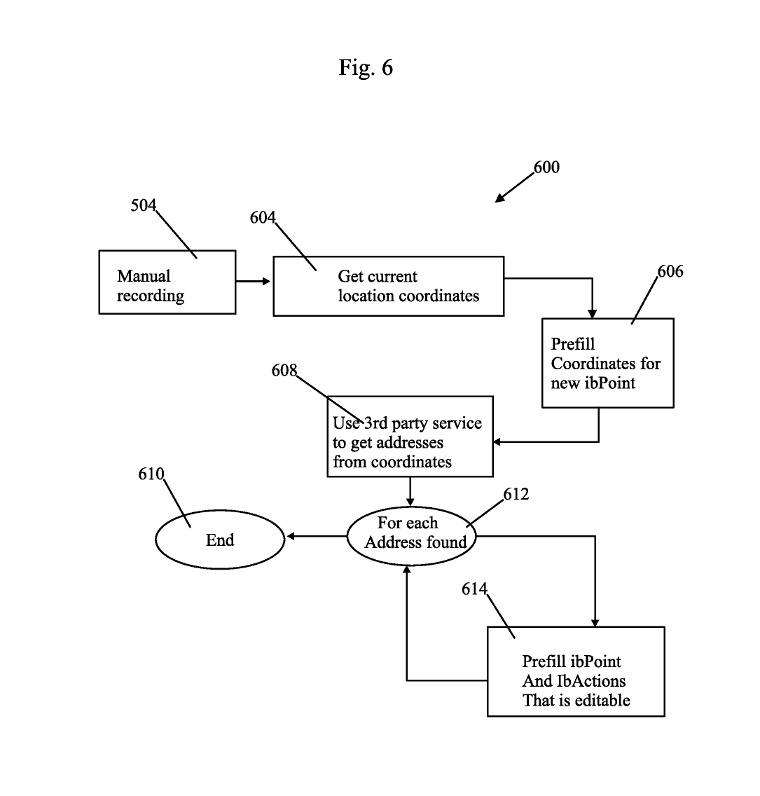

FIG. 6 shows a flow chart of a manual recording process 600 executed by the mobile device computer processor 4 and/or the server computer processor 104 of FIG. 1B, as programmed by computer software stored in the mobile device computer memory 2 and/or the server computer memory 102 of FIG. 1B. The manual recording process 600 starts at step 504 which may be a heading or overall title of the process. At step 604 the mobile device computer processor 4 is programmed to obtain the current geographic location coordinates of the mobile device 1, such as via the sensor 12. The mobile device computer processor 4 may record the obtained current geographic location as an ibPoint data object in the computer memory 2 and/or the server computer memory 102. The sensor 12 may obtain the geographic coordinates of the current location automatically, so the coordinates are pre-filled for this prospective ibPoint data object.

Description and detail referring to the obtained geographic location, (such as name of location or other information) may be filled in by the mobile user, through computer interactive device 8. At step 606, description and detail may be pre-filled in computer memory 2 or server computer memory 102 by doing a reverse lookup of address from geographic coordinates through a service such as Google (trademarked). There are existing service available which makes this possible e.g. Google (trademarked) geocoder. In at least one embodiment, a query may be made to ibContextServer 214 or server computer 100 to get the description related to this particular obtained geographic location. The ibContextServer 214 or server computer 100 communicates with the public service to return the description set for the obtained geographic coordinates, such as at step 608 to get addresses associated with coordinates. For each address found at step 612, the mobile device computer processor 4 may prefill ibPoint data objects and IbActions data objects with the appropriate data in mobile device computer memory 2 and in server computer memory 102 at step 614. When all addresses have been processed the procedure ends at step 610.

Note that there may be more than one result returned. In at least one embodiment the IbRecorder module 202 will give the user the option to add each of these results as ibPoint such as through a menu of selections on the mobile device computer display 10, which can be selected by the user using mobile device computer interactive device 8. However, the user may decide to add only some of them or none of them.

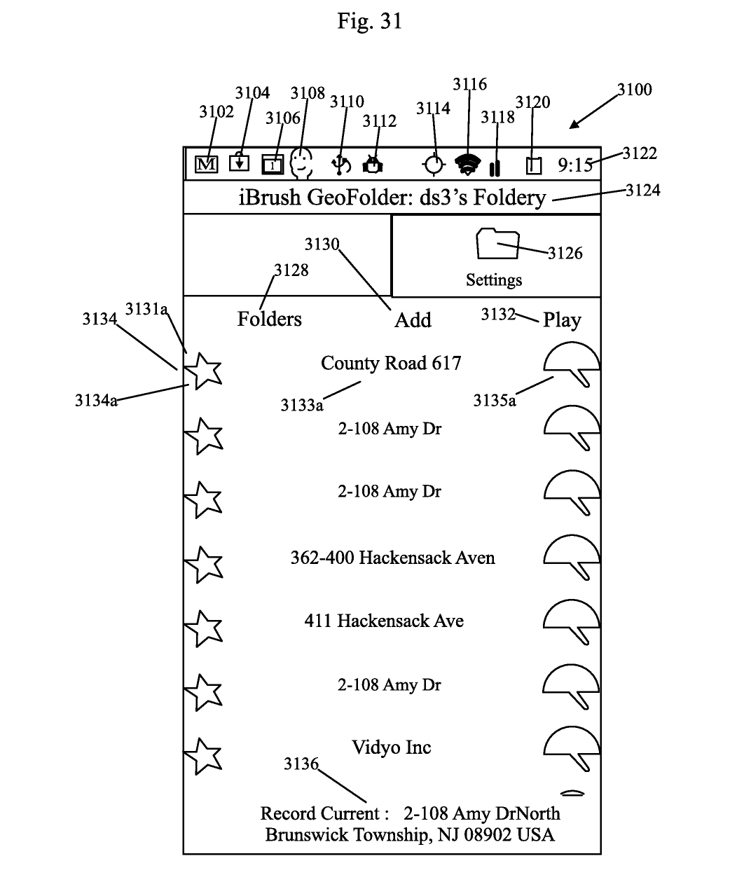

Also, each result from geocoder, such as Google (trademarked) may contain keywords like phone number or web site. Using these keywords, the ibRecorder module 202, as executed by mobile device computer processor 4, may be programmed to pre-fill prospective ibActions, in this example a phone ibAction and a web ibAction right away. Once again the user has the option to take this data as it is or edit them or not accept them at all. FIG. 31 shows a list of all the current added IBPoints in plurality of rows 3134. FIG. 31 also shows a button at the bottom titled “Record current” 3136. Using the GPS of the mobile device, which may be part of mobile device location sensor 12 shown in FIG. 1A, or part of mobile device computer processor 4 in FIG. 1A, the current coordinates are obtained as in step 606 shown in FIG. 6. These current coordinates, in at least one embodiment, are translated to an address (in this case “2-108 Amy Drive” as in step 608. Just by pressing this button, or field 3136 shown in FIG. 31, the IBPoint can be added for editing. To make changes, select the button on the right side of each IBPoint in FIG. 31 and edit either the description or the coordinates. Once the user is done editing the data, the user confirms which adds this data as a set of ibPoints data objects and ibActions data objects in computer memory 2 and/or server computer memory 102.

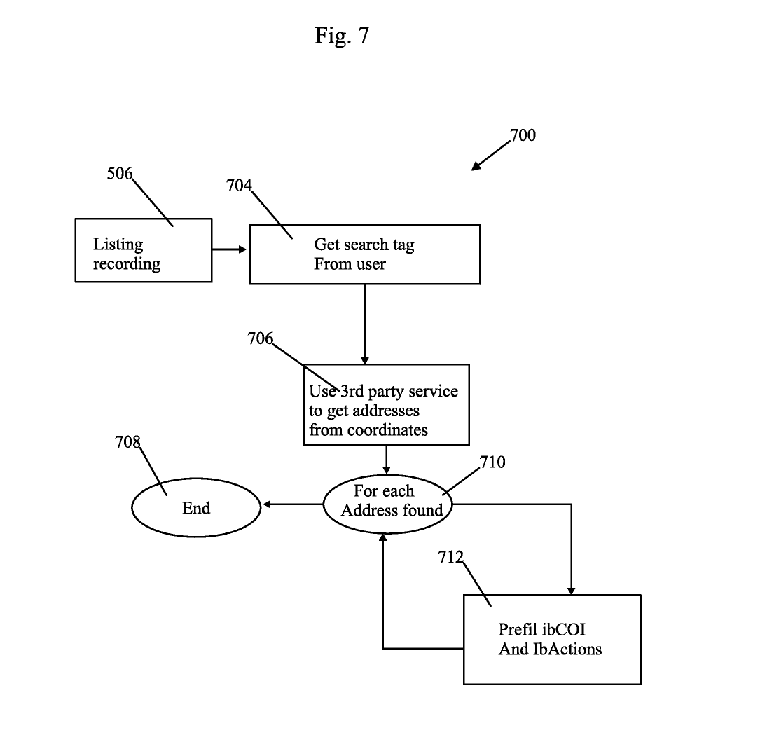

FIG. 7 shows a flow chart 700 of a listing recording process executed by the mobile device computer processor 4 and/or the server computer processor 104 of FIG. 1B, as programmed by computer software stored in the mobile device computer memory 2 and/or the server computer memory 102 of FIG. 1B. Step 506 is a start and/or heading for the listing recording process. At step 704 the user enters a search tag into the mobile device computer interactive device 8. For example, the user of the mobile device 1 may make a textual query (or search tag) for restaurants. The user may limits the number of results returned to five, and by default the computer processor 4 may set the limit at ten.

At step 706 a third party service, such as Google (trademarked) may be used to get addresses from coordinates. For example the ibRecorder module 202 of the mobile device 1, as executed by the computer processor 4, may send a query to ibcontextServer 214, via transmitter/receivers 6 and 106. In at least one embodiment, IbContextServer 214 makes a query to a public service e.g. Google (trademarked) geocoder providing the search terms as well as the mobile device geographic coordinates. Based on that, the public service returns results to ibContextServer 214, which returns the results back to ibRecorder module 202 of the mobile device 1. Please note that in this case or any other case, it is possible to make geocoder requests go directly from ibRecorder 202 rather than going to the ibContentServer 214.

Note that there may be more than one result returned. IbRecorder 202 will attempt to give the user the option to add each of these results as an ibPoint data object into computer memory 2 and/or computer memory 4, through a menu displayed on the mobile device computer display 10, which is not shown but may be a simple selectable list. However, the user may decide to add only some of the results or none of them. Once the user is done editing the pre-filled data, the user confirms and ibRecorder module 202 stores this data as a set of ibPoints and ibActions in computer memory 2 and/or computer memory 102 at step 712. When all addresses have been done, the procedure ends at step 708.

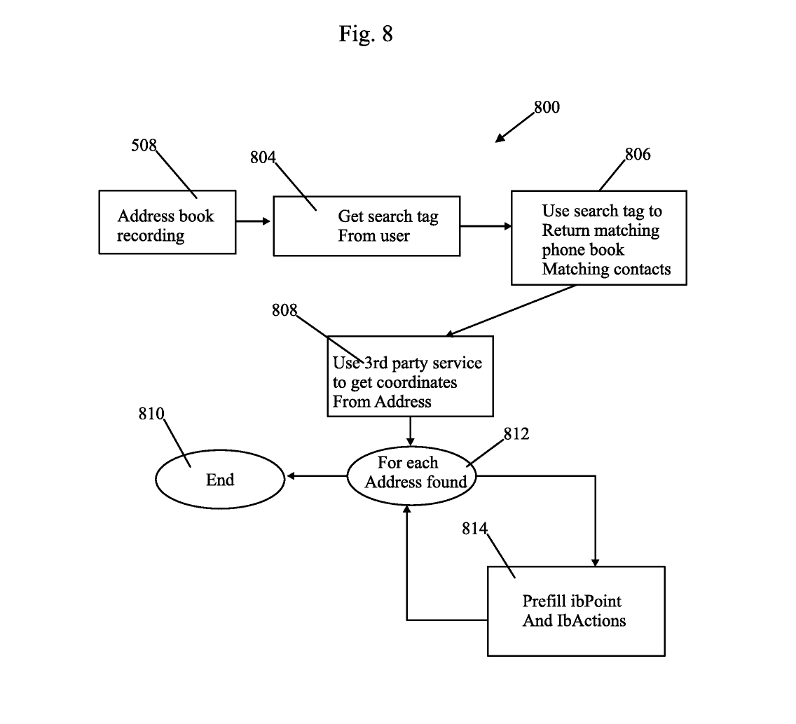

FIG. 8 shows a flow chart 800 of an Address book recording process executed by the mobile device computer processor 4 and/or the server computer processor 104, as programmed by computer software stored in the mobile computer memory 2 and/or the server computer memory 102. A similar or identical process in accordance with one or more embodiments of the present invention can be used to record social media contacts e.g. Facebook (trademarked) friends, Twitter (trademarked) followers or LinkedIn (trademarked) contacts. At step 508 is a start and/or heading for the address book recording process. At step 804 a user enters a search tag or search term into the mobile device computer interactive device 8. The user of the mobile device 1 may enter, for example, a textual query “e.g. 732”, with an intention to fill all contacts in the area code 732. Most platforms (such as internet search services, such as Google (trademarked), Facebook (trademarked), Twitter (trademarked) and LinkedIn (trademarked) provide methods to make queries to computer software applications (such as an address book or social network). For example an Android (trademarked) internet or mobile device platform has a well defined content provider method to make queries to an address book. Similarly Facebook (trademarked), Twitter (trademarked) and LinkedIn (trademarked) have REST (Representational State Transfer)/JSON (Java Script Object Notation) based services. Using this method, ibRecorder module 202 of the mobile device 1, gets the results from an address book of a platform or internet service at step 806, through that the ibRecorder module 202 has the address book record set as prospective ibPoints in computer memory 2 or computer memory 102, but the ibRecorder module 202 does not have the coordinates.

In at least one embodiment, for each record, a query is made to iService (an internet service such as Google (trademarked) to fetch geographic coordinates for the address at step 808. Again, in similar manner as described above, ibcontextServer 214 of FIG. 2 calls a public service like Google (trademarked) geocoder to find the coordinates of the subject address.

Once the results are available to ibContextServer 214, the coordinates are returned back to ibRecorder module 202 of the mobile device 1. Now the ibRecorder module 202 has all the information available to store this contact record as an ibPoint data object in computer memory 2 or computer memory 102.

The user can edit the pre-filled data and confirm through mobile device computer interactive device 8, in response to the user's confirmation the ibRecorder 202 may be programmed to add and/or store this data as a set of ibPoints and ibActions in computer memory 2 and computer memory 102 at step 814. A loop is repeated for each address found as shown by step 812 and when all addresses are done, the procedure ends at step 810.

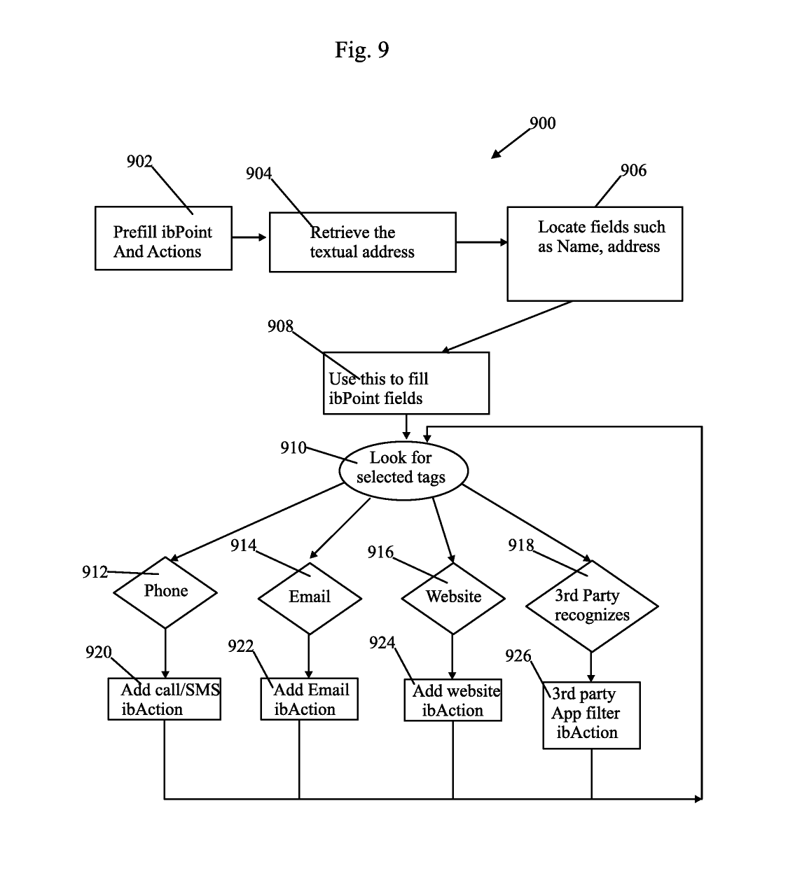

FIG. 9 shows a flow chart 900 of how ibActions are generated from IbPoint and its description, which starts at step or heading 902, executed by the mobile device computer processor 4 and/or the server computer processor 104, as programmed by computer software stored in the mobile device computer memory 2 and/or the server computer memory 102.

When public listing is fetched by ibRecorder 202 or contacts are imported, by the mobile device computer processor 4 of the mobile device 1, the ibRecorder module 202 has a series of records in the form of text that can be prospective ibPoints to be stored in computer memory 2 and/or computer memory 102 as described earlier. Now, it is described how to use this information to generate a set of iActions for each point.

At step 904, the ibRecorder module 202 retrieves the textual description from a user entry into mobile device computer interactive device 8. At step 906, the module 202 prepare a set of fields to look for if the user entry is a well defined structure like contact. At step 908 the mobile device computer processor 4 uses the set of fields of step 906 to fill ibPoint data object fields in computer memory 2 and/or computer memory 102.

At step 910 the mobile device computer processor 4 and/or the computer processor 104 look for multiple search tags, such as phone at step 912, Email at step 914, Website at step 916, and third party recognized text at step 918. If the tags phone, email, website, or third party recognized text are found, the next step is steps 920, 922, 924, and 926, respectively. For the phone case, at step 920, the Add call/SMS ibAction is added to the computer memory 2 and/or the computer memory 102.

For the phone case, the phone number is extracted from the tag phone at step 920. Create a Phone and SMS ibAction using the phone number are parsed by the mobile device computer processor 4, and stored in computer memory 2. This means that when this ibPoint is active on the ibRenderer module 204 of the mobile device, there will be an option to call or SMS (short message service) the given ibPoint data object as an option on a screen (as shown in image 2700 of FIG. 27, which may be described as showing an “augmented reality view”) of the mobile device computer display 10 for controlling the ibRenderer module 204. On selecting either of the call or SMS options, the configured phone number may be called by the mobile device computer processor 4.

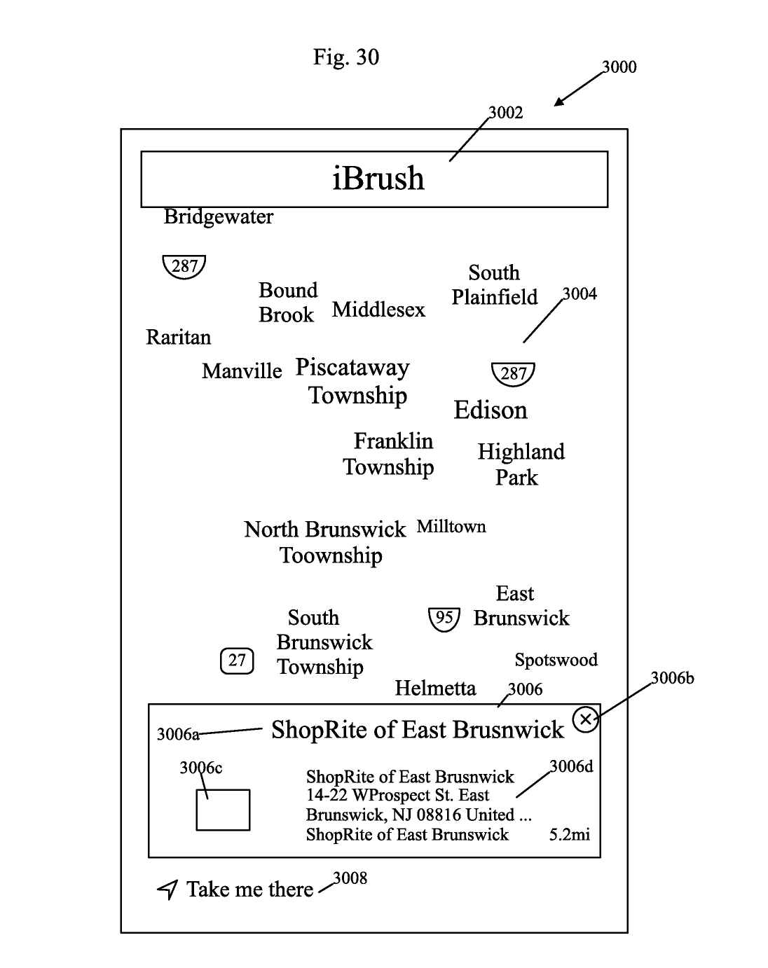

Similarly if Email tag is found at step 914 by the mobile device computer processor 4, an Email ibAction is created at step 922 and stored in the computer memory 2 and/or the computer memory 102 as described (as shown in FIG. 27 (also called an “augmented reality view”), FIG. 29 (also called a “List view”) or FIG. 30 (also called a “Map view”).

If a website tag is found at step 916, the web ibAction is created by the computer processor 4 and/or the computer processor 104 as shown in FIG. 27 (Augmented reality view), FIG. 29 (List view) or FIG. 30 (Map view).

Additionally, the overall computer software application program running on the mobile device computer processor 4 (called “iBrush”) can be preconfigured to deal with additional tags. beyond what is shown in FIG. 9. For example, a third party application like related contacts can be triggered to be called when an email tag is discovered. When an internet browser named ibBrowser, computer software application program running on the mobile device computer processor 4 discovers an Email, in at least one embodiment it calls this related contacts computer software application program on processor 4 and/or processor 104, to process this email and returned results. The computer software application “Related contacts” might itself look at the groups this email id belongs to in the address book and return those contacts.

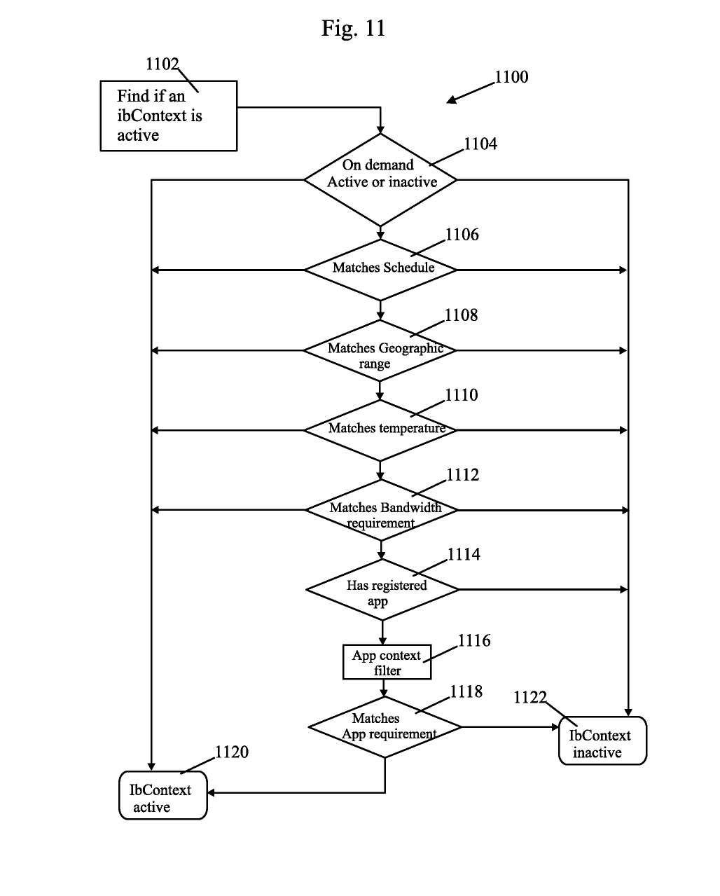

FIGS. 10 and 11 deal with when to make a context active, in computer memory 2 and/or computer memory 102, for a given user for a given set of conditions. After the process shown in FIG. 11 is executed by the mobile device computer processor 4, the “iBrush Renderer” module of computer software stored in computer memory 2 and executed by mobile device computer processor 4, knows the contexts that are active.

FIG. 10 shows a flow chart 1000 of a find list of contexts for a user process executed by the mobile device computer processor 4 and/or the server computer processor 104, as programmed by computer software stored in the mobile device computer memory 2 and/or the server computer memory 102. FIG. 10 shows how the overall controlling computer software program executed by the mobile device computer processor 4 (called “iBrush”) determines a set of ibContexts available to a given user, in at least one embodiment. In at least one embodiment, the overall controlling computer software program “Ibrush” follows the subscription model. By default, a user is subscribed to all the ibContexts that he or she has created, which may be stored in computer memory 2 and/or computer memory 102. Additionally, the user is subscribed to all the public contexts, which may be stored in computer memory 102. And the user might also be subscribed to certain contexts, stored in computer memory 102 by virtue of being member to certain groups.

At step 1002 of FIG. 10, the mobile device computer processor 4 may find a list of contexts for a user at step 1002 from a subscription table 1004 which may be stored in computer memory 2 and/or computer memory 102. At step 1006 it is determined if a user has subscribed. If the answer is yes, then at step 1008 it is determined if the ibContext is active as determined by a method executed by the computer processor 4 shown in FIG. 11. If the answer is yes, then the mobile device computer processor 4 and/or computer processor 104 sets a particular IbContext to active in computer memory 2 and/or computer memory 102 for this particular user at step 1008 and this is added to the particular user's active ibContexts at step 1010. The procedure ends at step 1012.

Not all ibContexts that a user is subscribed to are active at a given time. There will typically be a process by which ibRenderer computer module 204 executed by the mobile device computer processor 4 determines the active ibContexts for a user.

FIG. 11 shows a flow chart 1100 of a process to find if an ibContext is active, which is executed by the mobile device computer processor 4 and/or the server computer processor 104, as programmed by computer software stored in the computer memory 2 and/or the computer memory 102. Step 1102 is a heading or entry step into the process.

The process shown by flow chart 1100 can be made very dynamic. In accordance with one method of an embodiment of the present invention, a given set of common real time conditions are gone through to determine if a particular ibContext for a particular user needs to be activated. These set of conditions can be different from scenario to scenario. Failure to match a condition is a sufficient condition, in at least one embodiment, for the mobile device computer processor 4 or the server computer processor 104 to turn an ibContext off by storing in computer memory 2 or 102 an indication that the ibContext is “turned off” or not activate. This implies that no IBPoints from that IBContext will be shown on a IbRenderer 204. Users will not be able to select this IbPoint or act on any IBAction for this IBPoint. Success in matching a condition, in at least one embodiment, is a sufficient condition for the mobile device computer processor 4 or the server computer processor 104, as programmed to activate an ibContext, such as by storing an indication in computer memory 2 or 102 that the particular ibContext is “activated”. Absence of this condition is treated as moving over to the next condition, by the mobile device computer processor 4 or the server computer processor 104, as programmed by a computer program stored in memory 2 or 102. Alternatively, the computer processors 4 or 104 can be programmed by computer software to mark each condition as necessary or optional as well as sufficient or not sufficient, by storing an appropriate flag or indication in computer memory 2 or 102.

At step 1104, the mobile device computer processor 4 and/or the server computer processor 104 is programmed to determine if the particular ibContext is on demand, and if so, then the processor 4 and/or 104 determines if the ibContext has been activated manually by the particular user. If the particular ibContext has been activated, it is made inactive at step 1122, and if it is not activated manually, this ibContext is turned off as in step 1122. If it is not on demand, next step is executed at step 1106.

If no schedule is set for the ibContext as determined at step 1106, the next step is executed at step 1108. If a schedule has been set as determined at step 1106, it is determined if the current time matches the specified schedule and if it does, the schedule is activated at step 1120.

If a geographic range has been set for the ibContext as checked at step 1108, the next step is executed at step 1110. If a geographic range has been set for the ibContext at step 1108 set at step 1108, it is specified as a set of coordinates (latitude, longitude and altitude). If the current coordinates of the mobile device 1 (as obtained by a GPS or other sensor for sensor 12) is at a distance of more than a cut off limit, the next step 1110 is executed. Else, the current ibContext is active.

At step 1110 it is useful to specify weather based ibContexts. For example, if it is raining, it is more important to look for an indoor parking listing. A similar temperature based idea is given as an example here. If at step 1110 it is determined that a temperature based condition is not specified, the next step 1112 is executed. If at step 1110 it is determined that a temperature based condition has been specified, it is specified as a range of temperature within which the ibContext will be active. The overall computer software application running on the mobile device computer processor 4 and/or server computer processor 104 called “Ibrush”, need not necessarily need a mobile device based thermometer, but can get the current temperature from a web service via transmitter/receivers 6 and/or 106. If the temperature falls within the range, the ibContext is set active at step 1122, else next step 1112 is executed.

There may be network bandwidth intensive ibPoints data objects that don't make sense when the mobile device 1 is constrained in bandwidth. The condition of step 1112 tries to meet this use. If, as determined at step 1112, a bandwidth based constraint is not specified, the next step 1114 is executed. If bandwidth based condition is specified at step 1112, it is specified as range of numbers. If the current bandwidth does not fall within this range of numbers, the next step 1114 is executed. Otherwise, the ibContext is set active by storing indicator in computer memory 2 and/or computer memory 102 at step 1122.

The current context may be activated depending on the state of a third party computer software application. For example, an ibContext data object may be exposing contacts for a conferencing application. In at least one embodiment, it may only be valid, if the conferencing application is actively in conference.

If no third party filter has been registered for this ibContext at step 1114, this ibContext is not active (if there were more conditions—those conditions would have been executed but in this case, this is the last condition). But if a third party filter is set, as determined at step 1114 that filter is called through inter process communication. As parameters to this call, certain parameters like coordinates and other states of the overall computer software program running on mobile device computer processor 4 and/or computer processor 104 (called “iBrush”) may be sent. On receiving this request, the third party filter may communicate with the third party application and determine if the ibContext needs to be active or not, at steps 1116 and/or step 1118.

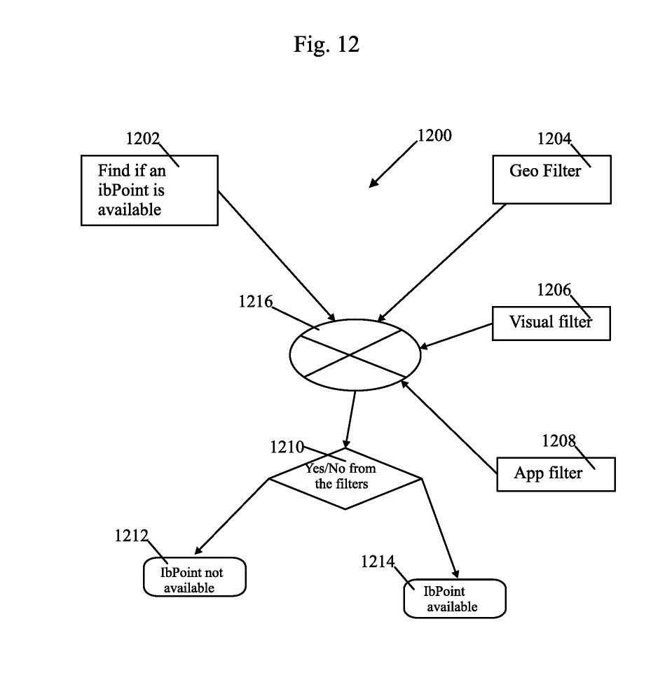

FIGS. 12-16, generally speaking, describe the use of different filters to determine a list of ibPoints belonging to one of the active ibContexts after the computer processor 4 loops through every active ibContext as determined by a method executed by the computer processor 4 as shown by FIG. 11.

FIG. 12 shows a flow chart 1200 of a find if ibPoint is available process executed by the mobile computer processor 4 and/or the server computer processor 104, as programmed by computer software stored in the computer memories 2 and/or 102.

Now it is to be determined if an ibPoint is available, at step 1202, i.e. if the particular ibPoint for a particular user, is to be shown on the mobile device computer display 10 by the computer processor 4 executing the ibRenderer module 204. IbRenderer module 204 queries ibContextServer 214 through the ibRenderer API or IbRenderer Server 210. The ibContextServer 214 or computer server 100 queries a Geo-filter 1204, a Visual-filter 1206, and an App-filter 1208, set currently. If any of the filters 1204, 1206, or 1208 returns a “Yes”, at step 1210, then the ibPoint is set active or set available at step 1214 in computer memory 2 and/or computer memory 102. If any of the filters 1204, 1206, or 1208 returns No, then the particular ibPoint is set not active or not available in computer memory 2 and/or computer memory 102 at step 1212. If any of the filters 1204, 1206, or 1208 returns neutral, then the decision that this ibPoint is active or not is not determined by this filter. If all filters 1204, 1206, and 1208 return neutral (neither “yes” nor “no” answer), the ibPoint is set not active or not available in the computer memory 2 and/or computer memory 102.

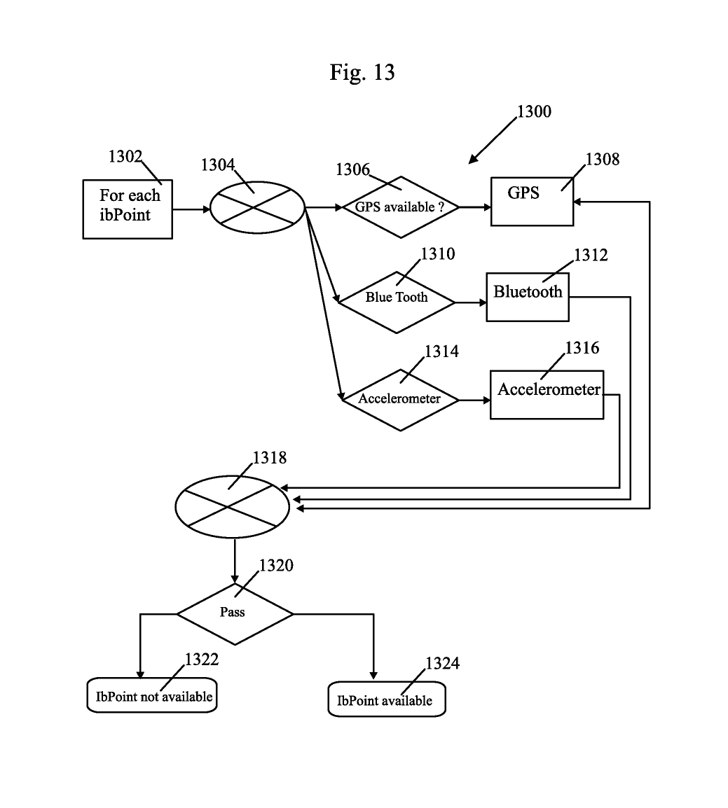

FIG. 13 shows a flow chart 1300 of a geo filter, which can be used for geo filter 1204 for each ibPoint for a geo filter process executed by the mobile device computer processor 4 and/or the server computer processor 104 as programmed by computer software stored in the mobile device computer memory 2 and/or the server computer memory 102.

The processor of flow chart 1300 for geo-filter 1204 determines if a given ibPoint is active. The geo-filter 1204 or process 1300 can not always rely on something like GPS, as inside building GPS is not accurate. On the other hand, an accelerometer is not very accurate, but is not dependent on being inside or outside a building. Bluetooth based methods depend on installation of hardware and therefore can provide solution only in locations where it is available.

So for the geo-filter 1204 or method of 1300, for each point at step 1302, passing to step 1304, and then at step 1306 GPS is tried first. If GPS is not available at step 1306, then bluetooth is tried at step 1310 followed by accelerometer at step 1314. Coordinates are retrieved from whatever technique was applied at steps 1308, 1312 or 1316 and supplied through step 1318 to step 1320 where it is determined if any ibPoint in the ibContext is active or available. From the coordinates are retrieved, distance of the coordinates from the given ibPoint as the logic iterates over each ibPoint in the ibContext—finding the distance from the current coordinates. If the distance is less than the cutoff, ibPoint is active, else not. If yes available, then IbPoint available variable is set to available in computer memory 2 and/or computer memory 102 at step 1324 otherwise IbPoint not available variable is set in computer memory 2 and/or computer memory 102.

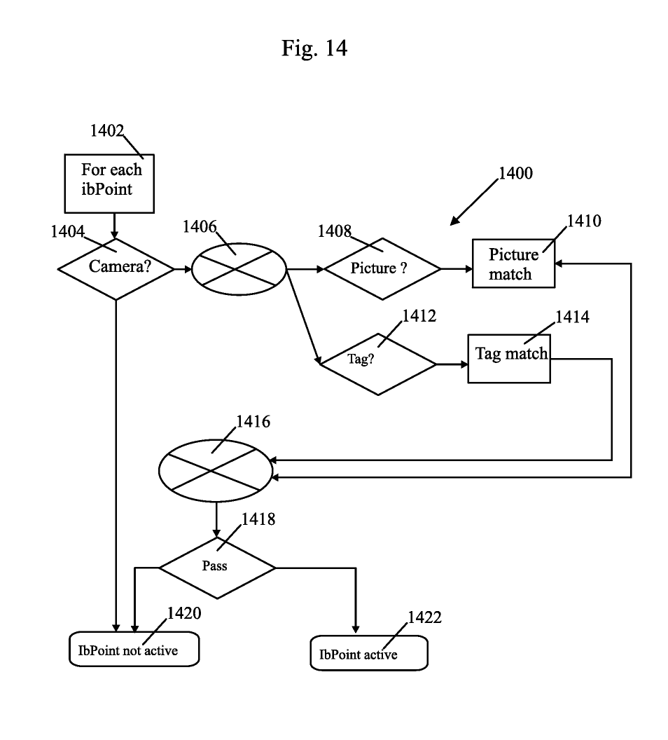

FIG. 14 shows a flow chart 1400 for the visual filter 1206 executed by the mobile device computer processor 4 and/or the server computer processor 104 as programmed by computer software stored in the mobile device computer memory 2 and/or the server computer memory 102. A visual filter 1206 may be beneficial to augment accuracy because of inaccuracy in locating ibPoints. For example, if the ibPoint is indoor. A visual filter 1206 may be useful because the ibPoint may not have a fixed location or may be many points characterized by a unique look—eg an item for sale characterized by its price tag. A picture based filter may be used for a visual filter 1206 and may actually store a picture of an ibPoint. The mobile device computer processor 4 of the mobile device 1 may dynamically use the mobile device camera 14 to store the picture of the ibPoint in mobile device computer memory 2, from different angles. The limitations are mostly in accuracy of these methods. If we are trying to take a picture of a three dimensional object, a moving object, etc. chances of error are there. For example, if the ibPoint represents a rice bag stored in the kitchen, inaccuracies arise because the user may be looking at camera 14 from a different angle, the bag might be now half empty hence a different shape, the light conditions in the room may be different.

A tag based filter is more accurate where a unique tag is created for a ibPoint. The overall computer software program running on mobile device computer processor 4 and/or computer processor 104 (called “ibBrush”) is programmed by computer software stored in computer memory 2 and/or computer memory 102 to automatically create a random unique tag for an ibPoint in computer memory 2 and/or computer memory 102. This method is much more accurate. However, it is not practical to create a tag for every ibPoint in many scenarios.

At step 1402, the process is started for each ibPoint. At step 1404, it is determined by the computer processor 4 and/or 104 if a camera, such as camera 14 is to be used. If not, then in at least one embodiment, the ibPoint is set to not being active in computer memory 2 and/or 102 at step 1420. If the camera 14 is to be used, then through step 1406, and step 1408 it is determined if a picture is to be compared with the ibPoint, and if so, then it is determined if a picture stored in computer memory 2 and/or 102 matches a current picture for the IbPoint at step 1410, and if so through step 1416 if the pictures have matched, the ibPoint is made active at step 1422 by storing or setting a variable to an appropriate value at step 1422. If there is no picture match then ibPoint is set to not active in computer memory 2 and/or 102.

If a tag method was used at step 1412 then it is determined if tags matched at step 1414 by computer processor 4 and/or 104, and then through steps 1416 and 1418 it is determined whether the ibPoint should be set active or inactive at steps 1420 or 1422.

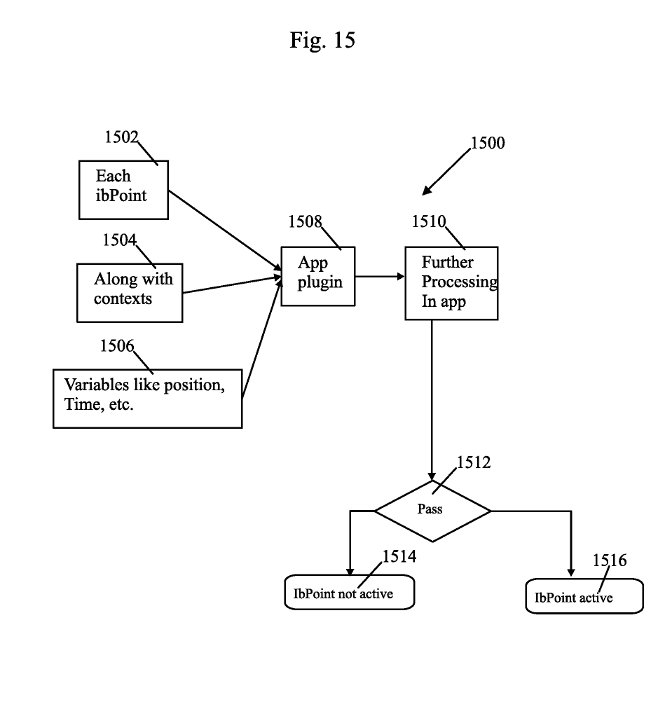

FIG. 15 shows a flow chart 1500 of an application filter for filter 1208 of FIG. 12, for each IbPoint process executed the mobile device computer processor 4 and/or the server computer processor 104 as programmed by computer software stored in the mobile device computer memory 2 and/or the server computer memory 102.

In the App based filter 1208, the overall computer software program running on mobile device computer processor 4 (called “iBrush”) calls a third party computer software application filter shown by process 1500—the one that is registered for this ibPoint. When the application filter 1208 or process 1500 is registered, it is notified whenever an ibPoint is to be added. At this point, the application filter 1208 or 1500 has the option to add a private-context at step 1504 to the ibPoint data of 1502. This is the private-context data 1504 that is passed back to the application filter when the query for ibPoint is done.

In at least one embodiment, the application filter 1208 is notified through an inter process communication method along with the parameters like context 1504, ibPoint details and the ‘iBrush’ variables like coordinates 1506. Based on these conditions and taking the help of a third party application, the application filter 1208 or 1500 returns to the overall computer software program (called “iBrush”) if the ibPoint is active or not. The information from steps 1502, 1504, and 1506 are added together in step 1508. Further processing is done at step 1510, and it is determined at step 1512 whether the ibPoint should be set not active at step 1514 or active in the computer memories 2 and/or 102 at step 1516 by the computer processors 4 and/or 104.

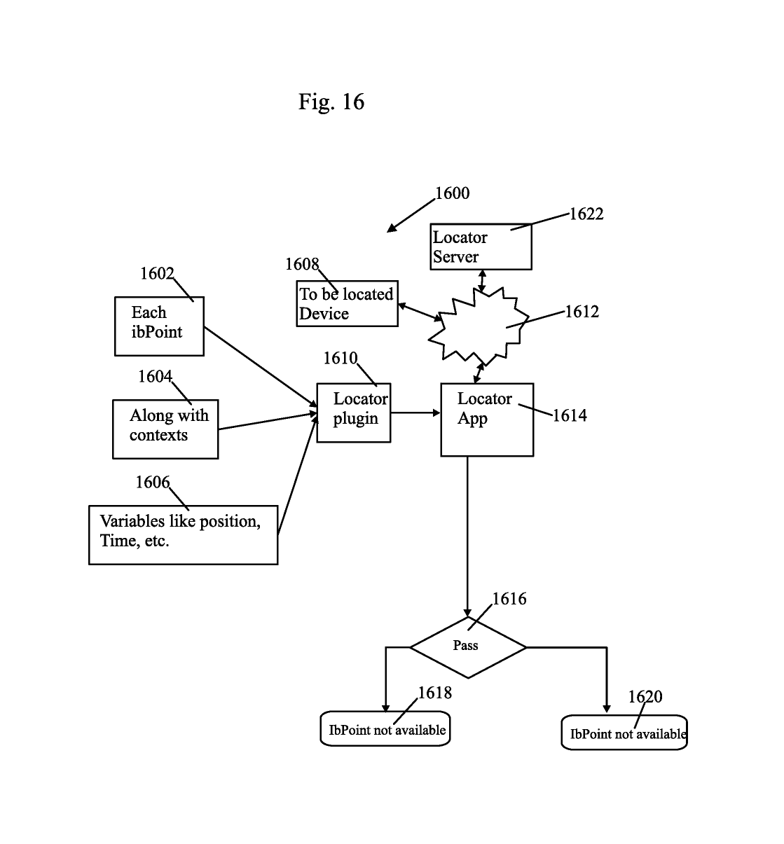

FIG. 16 shows a flow chart 1600 of an application filter for each IbPoint process executed by the mobile device computer processor 4 and/or the server computer processor 104 as programmed by computer software stored in the mobile device computer memory 2 and/or the server computer memory 102. A concept behind the flow chart 1600 is that sometimes ibPoints are not stationary, for example another mobile device. So let us say that one user—userA is walking through a crowded place trying to locate a group of people who are standing below an electronic placard that also is GPS enabled. The objective of UserA is to locate this group of people. So it is like a dynamic GPS where both locations are moving.

At step 1608, the mobile device computer processor 4, executing the overall computer software program (called “iBrush”) recognizes the electronic placard as an Application-filter based ibPoint, through the internet 1612 and the locator application 1614 on the mobile device 1. So to determine if the ibPoint is to be displayed or not, the mobile device computer processor 4 executing the overall computer program or “iBrush”) sends a message to a registered locator App-filter 1614 through an inter process communication. The request would also pass parameters like a ibPoint context which is a binary blob put by app-filter 1614 when the ibPoint was created. Additionally, other data like mobile device coordinates and time would be sent to the locator application 1614. For example data about each ibPoint 1602, along with contexts 1604, and variables such as position, time, etc. 1606 when be combined at step or plugin 1610 and sent to locator application 1614.

The Application filter 1614, which may be stored in computer memory 2 and executed by computer processor 4 of the mobile device 1. The application filter 1614 by itself does not do anything. It takes the help of Locator server 1622 to determine if an ibPoint is active. Locator server 1622 is updated by queried single other mobile object 1608 represented on the current mobile display 10 as an ibPoint. Depending on parameters notified to the Locator server 1622—it is determined if ibPoint is to be displayed or not on the mobile device computer display 10.

The application filter 1614 may pass all requests to the locator application 1614 which actually provides the functionality. For a simple application, these two modules can be the same and are shown as 1614 in FIG. 16.

The Locator computer application 1614 is running on the mobile device 1. Through a network request, through network or internet 1612 the application 1614 (and the mobile device 1) communicates with a locator server 1622 (accessible over WAN (wide area network) running as a service e.g. REST (Representation State Transfer)/JSON (Java Script Object Notation) based service.

The Locator server 1622 may have a communications link with an electronic display of the mobile device computer display 10. In at least one embodiment, the locator server 1622 may just be an optional sub module computer program of the ibContextServer 214.

The locator server 1622 may send a message to the electronic display of mobile device computer display 10 to send the current location of the mobile device 1 back to the locator server 1622. Meanwhile, locator server 1622 on receiving the location of the electronic display or display 10 of the mobile device 1 can determine if the to be located device 1608 and the mobile device 1 are close together since Since 1608 is sending its geo coordinates to locator server as is locator app 1614. Using the two sets of information, location server 1622 determines the proximity of to be located device 1608 as a ibPoint.

The locator server 1622 can send a message to the electronic display of display 10 to light up the display with a specific message. At the same time the locator server 1622 can pass the coordinates of the electronic display of the display 10 back to locator application on the mobile device 1 which goes back to the overall computer program (called “iBrush”) of the mobile device 1 through the ibRenderer Server 210, also called ibRenderer Server Api.

On receiving the coordinates of the electronic display of the mobile computer device display 10, the overall software program called “iBrush” running on the mobile computer device 1 can show the electronic display in the augmented reality view or map very precisely on the mobiled computer device display 10. With the help of display 10 on the electronic display and the ibRenderer browser computer program executed by the computer processor 4, userA should be able to view the electronic display of display 10 easily.

In FIG. 16, the computer processor 4 can determine if the ibPoint is not available or available and set appropriate variables in computer memory 2 and/or computer memory 102 through steps 1616, 1618, and 1620.

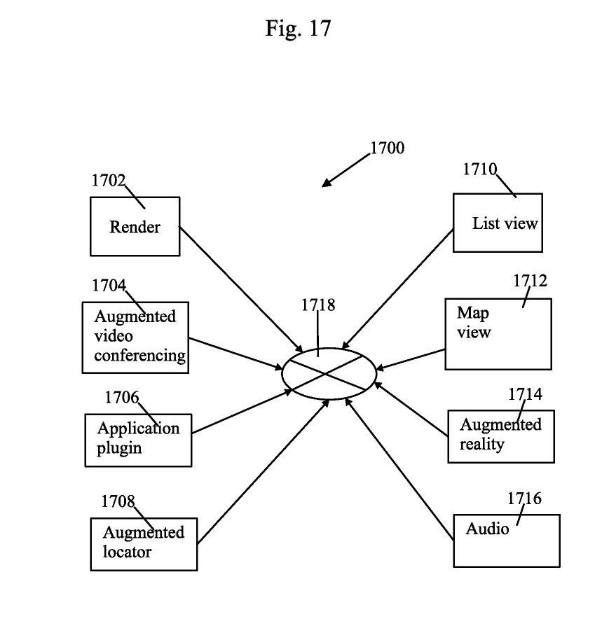

FIG. 17-FIG. 22, generally speaking, deal with rendering the described active ibPoints along with their ibActions on different renderers.

FIG. 17 shows a flow chart 1700 of an application filter locator for each IbPoint process executed by the mobile device computer processor 4 and/or the server computer processor 104 as programmed by computer software stored in the mobile device computer memory 2 and/or the server computer memory 102. FIG. 17 describes a situation where the ibPoint and IbActions to display at a given time are already known to the mobile device computer processor 4 and/or the sever computer processor 104. The process shown by flow chart 1700 specifies how to display the ibPoint and ibActions to the user on the mobile device computer display 10 using at least one of various approaches.

Once the ibRenderer module 204 of the mobile device 1 gets a notification to display an ibPoint on the mobile device computer display 10 the ibRenderer 204 can cause one of many views to be displayed on display 10 depending on the configuration. For example, ibRenderer 204 can display a simple text based or list view 1710, with prompts for actions available, a map based view through step 1712, augmented reality view through step 1714, a voice or audio based view 1716, a locator type view through step 1708 using a display on ibPoint itself as described above, a third party application plugin based view 1706, or even a video conferencing view 1704. Each of them is described further. The display or rendering procedure may be entered through step 1702 of FIG. 17, and they different views may be combined or available through step 1718.

FIG. 18 shows a flow chart or process 1800 of a map based view render process or step 1712 executed by the mobile device computer processor 4 and/or the server computer processor 104 as programmed by computer software stored in the mobile device computer memory 2 and/or the server computer memory 102. Map based view or process 1800 can make use of a third party service like Google (trademarked) map. The process 1800 also allows points to be added and managed to be displayed on the map. When ibRenderer module 204 of the mobile computer processor 4 comes across an ibPoint is to be displayed on the mobile device computer display 10, the ibRenderer module 204 sends a message to the mapping service, via transmitter/receiver 6, to the internet, by adding the point to the map. Many of the mapping services allow certain actions to be taken on these points on the map. These actions are configured to correspond to ibActions for this ibPoint. Once the above step is done, the ibPoint is displayed on the map, on the mobile device computer display 10 along with all the action/options. Each available ibPoint at step 1802, along with contexts 1804, and variables 1806 can be combined into map view 1808 and uploaded with ibPoint and the particular ibAction at step 1810 as a point on a map displayed on the mobile device computer display 10.

FIG. 19 shows a flow chart 1900 of an augmented reality view process 1900 or 1714 executed by the mobile device computer processor 4 and/or the server computer processor 104 as programmed by computer software stored in the mobile device computer memory 2 and/or the server computer memory 102.

Augmented reality view can make use of third party service like Layar (trademarked) or Wikitude (trademarked). Some methods for displaying augmented reality views is well known publicly and one simple method is described below. Augmented reality view is augmenting a real world view (as seen by a camera) by computer/software generated images. In the description below it is assumed that the augmented reality view is an augmented view to a view as seen by camera.

When ibRenderer module 204 executed by the mobile device computer processor 4 comes across an ibPoint is to be displayed, it sends a message to the augmented reality service, such as an internet service via transmitter/receiver 6. The parameters sent with this request are the ibPoint (location coordinates) 1902 along with possible ibAction description, such as ibContexts 1904, and variables 1906, such as current GPS coordinates, and these are combined at step 1908.

At step 1910 if the camera is not on, such as camera 14, nothing further is done and the process ends at step 1912. It the camera 14 is on, the viewers' location is found based on sent parameters at step 1914, then ibPoint location with respect to the viewer with the camera 14 is determined at step 1916. At step 1918, ibPoint is drawn with ibActions on camera 14.

Based on the current GPS coordinates the viewer, generally, is the center of coordinates from which ibPoints are calculated, this central point can be something else too. For example the user specifies that he/she wants to view ibPoints at a different location. For FIG. 19 example, the viewer is assumed to be located at the point on the center of the camera (0, 0, 0). Using a three dimensional computer software graphics package, the ibPoint is converted to a coordinate on a screen of the mobile device computer display 10 at step 1916. In most cases this is a straight forward scaling of the ibPoint coordinates. At step 1918 the mobile device computer processor 4 is programmed to draw the ibPoint on the camera 14 screen and provide each ibAction as a menu option on the mobile device computer display 10.

FIG. 20 shows a flow chart 2000 of audio view process 1716 executed by the mobile device computer processor 4 and/or the server computer processor 104 as programmed by computer software stored in the mobile device computer memory 2 and/or the server computer memory 104. Audio reality view, in at least one embodiment may sending audio signals from mobile device computer processor 4 to the mobile device speaker 16 to cause the audio playing of the ibPoints list results described above. For the most part it may be exactly same as list view, except that the audio view plays the output on the speaker 16 rather than displaying it on the screen of the mobile device computer display 10. A third party computer software application tool may be used to convert text to speech or audio signals. A more sophisticated approach can also be followed where the description of the ibPoint can be stored as an audio file in the mobile device computer memory 2 and/or memory 102.

When ibRenderer 204 of the mobile device 1 comes across an ibPoint is to be displayed, it sends a message to the augmented reality service. The parameters sent to this request is the ibPoint (location coordinates) at step 2002, along with possible ibAction description or ibContexts at step 2004 as well as current GPS coordinates and variables at step 2006. These are combined in audio view step 2008 by mobile device computer processor 4. If the speaker 16 is not on at step 2010, nothing further is done, and the procedure ends at step 2012. If the speaker is on at step 2010, based on the ibPoint description and the ibActions, the audio content is prepared from text and played on the mobile device speaker 16 by the mobile device computer processor 4 at step 2014.

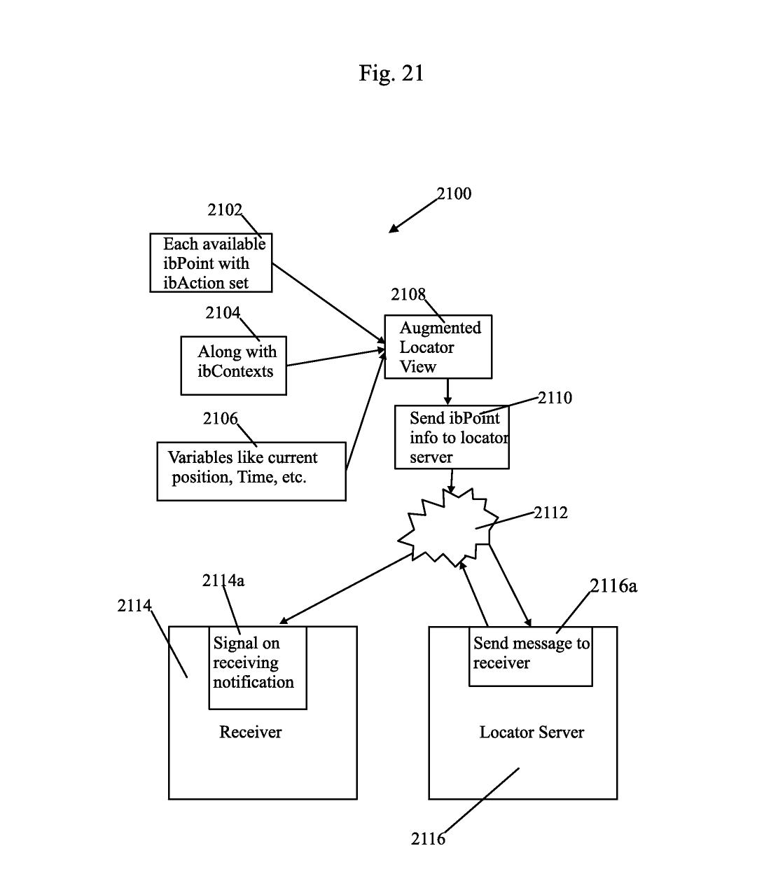

FIG. 21 shows a flow chart 2100 of an augmented locator view process 1708 or 2100, executed the mobile device computer processor 4 and/or the server computer processor 104 as programmed by computer software stored in the mobile device computer memory 2 and/or the server computer memory 102.

The augmented locator view process or 1708 and 2100 helps in locating points that have no fixed location. It should be noted that once the movable object is located, it can be displayed in any other view like list view, augmented reality or a map based view. However, in this example, we are not describing this aspect in detail as it is already described above. Instead, it is described how a flash is lit on the target ibPoint to make the target easily locatable in this case.

The parameters sent with the Augmented locator view request are the ibPoint (location coordinates) at step 2102, along with possible ibAction description or ibContexts at step 2104 as well as current GPS coordinates and variables at step 2106. These are combined in augmented locator view step 2108 by mobile device computer processor 4, and sent to a locator server 2116, at step 2110 through the internet 2112. The locator server 2116 can be an optional component of the ibContext Server 214. A receiver 2114 receives notification 2114a of the information. The locator 2116 sends a message to the receiver 2114 through 2116a and internet 2112.

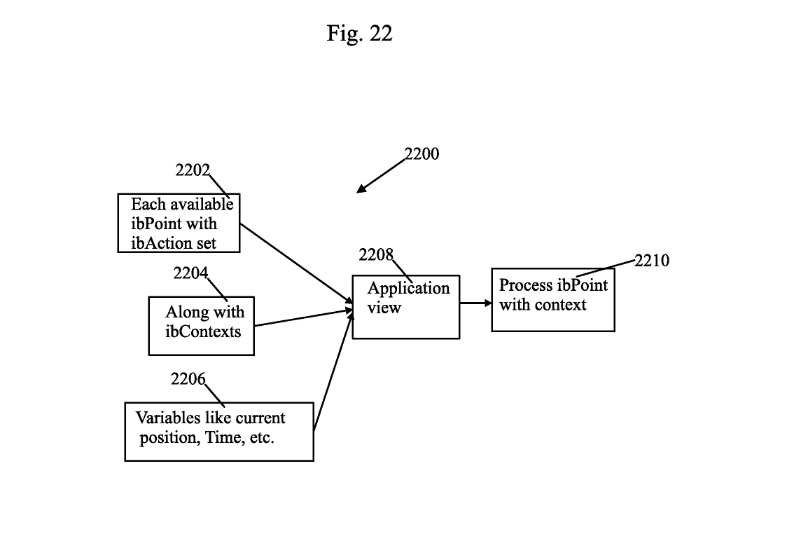

FIG. 22 shows a flow chart 2200 of an application view process 1706 or 2200 executed by the mobile device computer processor 4 and/or the server computer processor 104 as programmed by computer software stored in the mobile device computer memory 2 and/or the server computer memory 102. The parameters for the Application view are the ibPoint (location coordinates) at step 2202, along with possible ibAction description or ibContexts at step 2204 as well as current GPS coordinates and variables at step 2206. These are combined in Application view step 2208 by mobile device computer processor 4 and stored in computer memory 2 and/or computer memory 102 at step 2210.

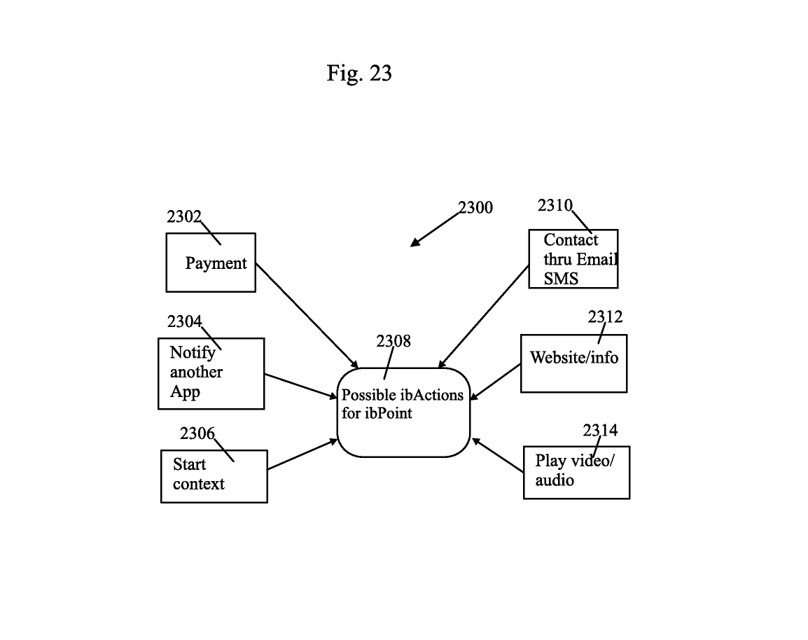

FIGS. 23-26 deal with different ibActions and how to deal with them.

FIG. 23 shows a flow chart 2300 of an ibActions process executed the mobile device computer processor 4 and/or the server computer processor 104 as programmed by computer software stored in the mobile device computer memory 2 and/or the server computer memory 102. One or more of the possible actions or data specifying such actions of payment 2302, notify other computer software application 2304, start context 2306, contact thru email SMS, website information 2312, and play video/audio 2314 are combined in step 2308.

Once an ibPoint is displayed by ibRenderer 204 on a mobile device computer display 10, the particular ibPoint gives mobile users options to click on different menu items on the mobile device computer display 10 representing ibActions. Different actions can be triggered, such as by touch screen on display 10, which may be part of computer interactive device 8, from the overall computer software program called “iBrush” running on the computer processor 4 of the mobile device depending on the ibAction clicked.

The ibAction to be executed by the mobile device computer processor 4 can be, for example, a phone call, SMS, or an Email at step 2310. The ibAction to be executed can also be a request to open a web site at step 2312, play a video or audio at step 2314 or send a message to an application at step 2304. It could also be a trigger to mobile based payment at step 2302 or a trigger to start another ibContext at step 2306.

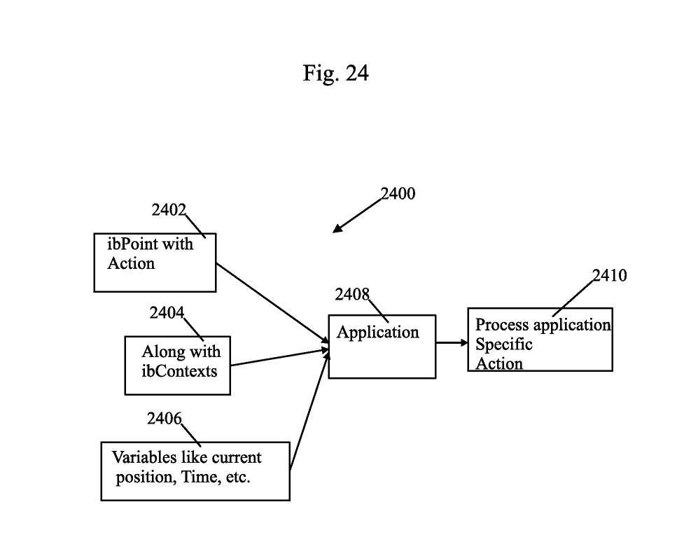

FIG. 24 shows a flow chart 2400 of an Application based ibActions process executed by the mobile device computer processor 4 and/or the server computer processor 104 as programmed by computer software stored in the mobile device computer memory 2 and/or the server computer memory 102. FIG. 24 describes how to process an application specific action. The parameters for the Application step 2408 are the ibPoint (location coordinates) at step 2402, along with possible ibAction description or ibContexts at step 2404 as well as current GPS coordinates and variables at step 2406. These are combined in Application step 2408 by mobile device computer processor 4 and stored in computer memory 2 and/or computer memory 102 at step 2410.

When the ibPoint is displayed on the mobile device computer display 10, the ibPoint has already been pre-configured for this specific ibPoint to have an ibAction that is an application specific ibAction. This means that when the user selects this option, an inter process communication is done to pass parameters to this third party application to further process it. An example is described below.

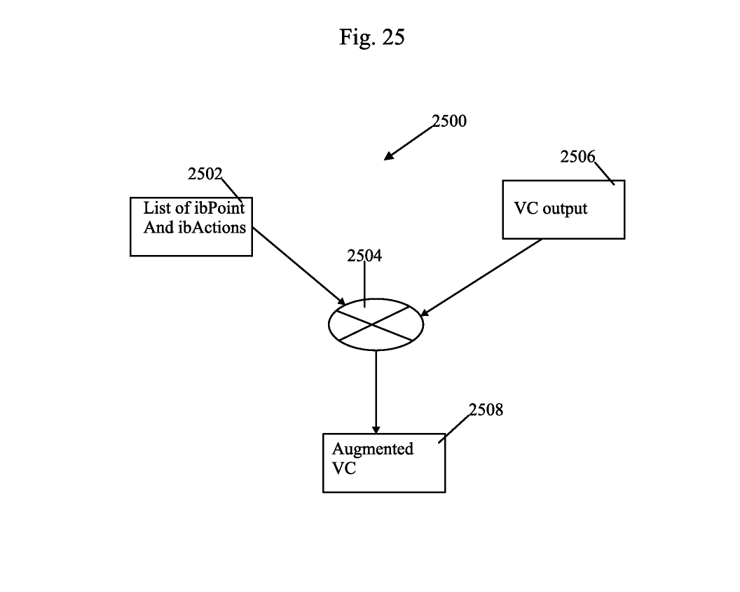

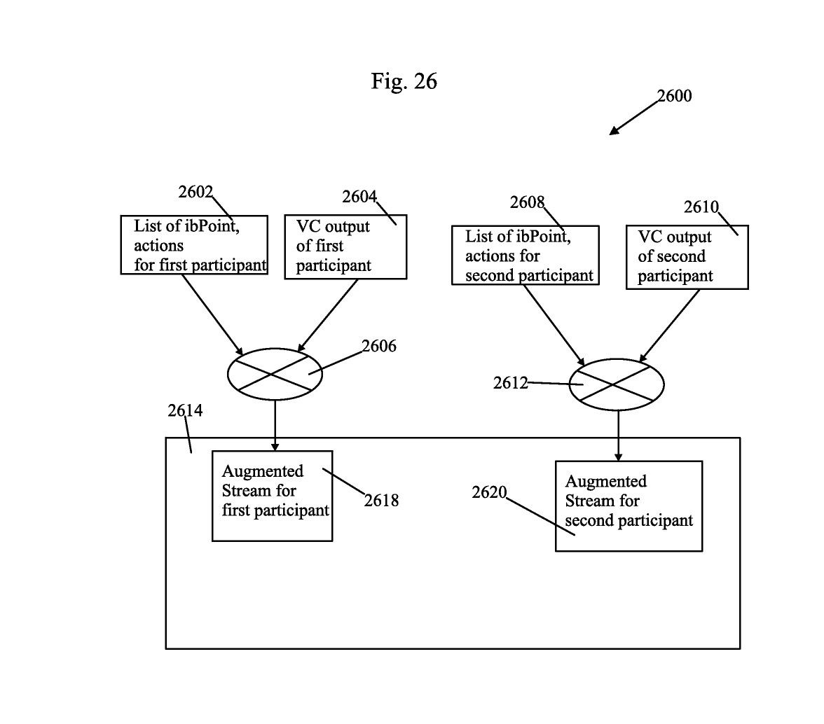

FIG. 25 shows a flow chart 2500 of an Augmented VC (video conferencing) process executed by the mobile device computer processor 4 and/or the server computer processor 104 as programmed by computer software stored in the mobile device computer memory 2 and/or the server computer memory 102. The overall computer software program “iBrush” is running in the background on the mobile device computer processor 4 and so is a video conferencing process VC. The overall computer software program “iBrush” gets a list of points that are currently active for this mobile user at step 2502. This is passed to the video conferencing process, via step 2504, along with the VC output 2506 to give an augmented video conferencing view at step 2508 described in the FIG. 26.

FIG. 26 shows a flow chart 2600 of an Augmented VC process 2600 executed by the mobile device computer processor 4 and/or the server computer processor 104 as programmed by computer software stored in the mobile device computer memory 2 and/or the server computer memory 102.

In FIG. 26 the video conferencing process is displaying a video conferencing view displaying multiple participants. For this example, each participant has an “iBrush” computer software application program running on a mobile device computer processor, similar to, or identical to processor 4, meaning the video conferencing process has a set of ibPoints active. Each users' ibPoints and ibActions are fed to the videoconferencing central router.

List of ibPoints, and actions for first participant at 2602 and VC output of first participant at 2604 are combined at 2606 to form an augmented stream for first participant at step 2618. Similarly, list of ibPoints, and actions for a second participant at 2608 and VC output of second participant at 2610 are combined at 2612 to form an augmented stream for the second participant at step 2620.

In at least one embodiment, a VC router sends display to each participant for all the participants along with the ibPoints and ibActions. This will let other users to do actions on other participants. For example, if a nurse is remotely monitoring patients, she will see each participant on the screen along with temperature control as ibAction for the participant. Using this ibAction, the nurse can control the temperature of each of the patient.

Generally speaking, one or more embodiments of the present invention deal with the problem of how to embed ibPoints and ibActions in the video conference window on the mobile device computer display 10 and/or in mobile device computer memory 2 and/or in server computer memory 4. More specifically, on the receiving side, the receiver of video conferencing window, on a mobile device, such as mobile device 1, through transmitter/receiver 6 and displayed on display 10 is seeing all the other participants in each participant subwindow on the display 10. The description referring to FIG. 26 deals with how to convert these subwindows 2604 and 2610 to 2618 and 2620. Since each participant has a geographic coordinate as do each ibPoints. So for each participant window, we know the ibPoints inside it. This information shown in steps or modules 2602 and 2608, are there with the Video conference MCU (multi point control unit) or routers. Now the augmented reality view can be prepared by the MCU itself, executed by the computer processor 4 or computer processor 104, or can be done by each Video conferencing client.

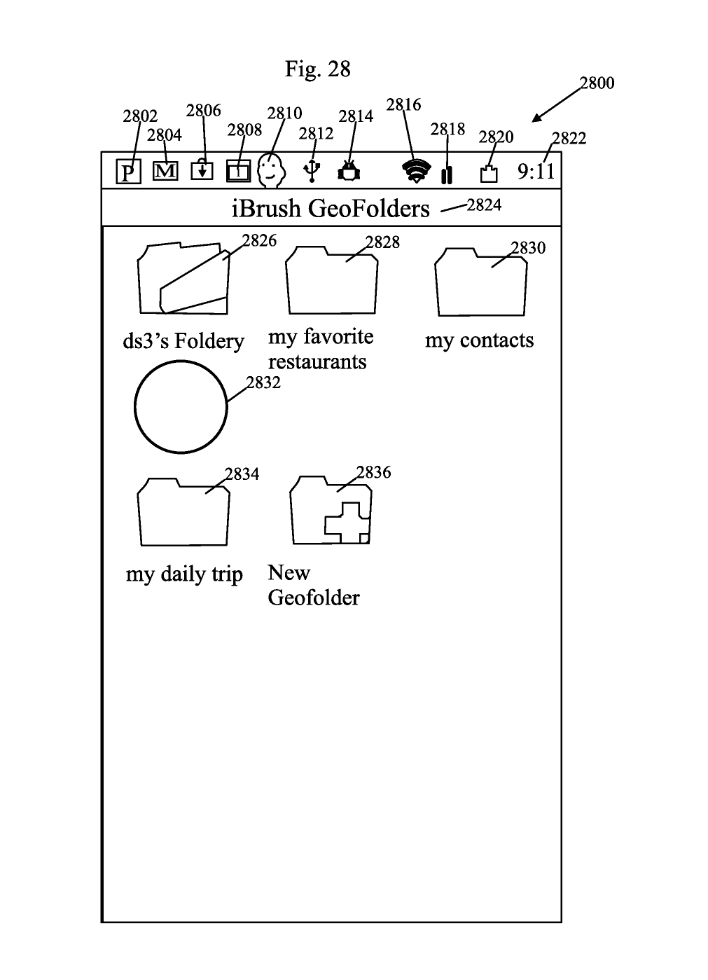

Please note that the images or views shown in FIG. 27 to FIG. 31 are typically not in exactly the same order or sequence, as the Figures shown. The sequential order, in at least one embodiment, is typically the image or view shown in FIG. 28, then the image or view shown in FIG. 31 followed by any of the images or views shown in FIG. 28, FIG. 29 or FIG. 30 depending on the type of view selected by the user.

FIG. 27 shows a first image 2700 which the mobile device computer processor 4 and/or the server computer processor 104 may cause to appear on the mobile device computer display 10 as programmed by computer software stored in computer memory 2 and/or computer memory 102 in accordance with an embodiment of the present invention. The image 2700 includes text 2702 indicating that nine points of interest have been found as a result of a search, such as a search that may be executed by step 1214 in FIG. 12 or more specifically in our case, a search that may be executed by step 1324 of FIG. 13, as steps 1214 and 1324 are examples of IBPoints coming from Geo Filter 1204 shown in FIG. 12.

The image 2700 also includes text 2704, 2706, 2708 which provide information for “Dinesh Slnha” including name and address. The image 2700 further includes text 2710 which indicates the distance from the mobile device 1 of FIG. 1A to the address shown in text 2706. The image 2700 further includes fields and/or software icons 2712, 2714, 2716, 2718, 2720, 2722, 2724, 2726, 2728, 2730, 2732, and 2734 which can be selected by touching a computer screen of the mobile device computer display 10 at the location on the screen where the particular icon is, to trigger an IBAction. For example, selecting image or field “SMS” 2720 triggers SMS (a short message service or a text message or SMS type text message) as in step 2310 in FIG. 23.

FIG. 28 shows a second image 2800 which the mobile device computer processor 4 and/or the server computer processor 104 may cause to appear on the mobile device computer display 10. The second image 2800 includes fields and/or software icons 2802, 2804, 2806, 2808, 2810, 2812, 2814, 2816, 2818, 2820, 2822 which generic phone indicators which are known to those skilled in the art. The second image 2800 also includes field 2824 which indicates to the user that user is viewing the list of IBContexts. The image 2800 also includes fields 2826, 2828, 2830, and, 2834 which are the IIBContexts available to the user, which can be selected by a touching the computer screen of mobile device computer display 10 at the location where the particular field and/or icon is, to view and manage all the IBPoints belonging to that IBContext as shown in FIG. 31. Selection of the field 2832 causes the selected IBContext 2826 to be displayed or viewed on the mobile device computer display 10 in an IBBrowser as shown in FIG. 27, FIG. 29 and FIG. 30. This also corresponds to the step 1008 in FIG. 10 where the current IBContext—2826 is marked active. Also, selecting 2836 creates a new IBContext.

FIG. 29 shows a third image 2900 which the mobile device computer processor 4 and/or the server computer processor 104 may cause to appear on the mobile device computer display 10. The third image 2900 may include a text title 2902 (which may be the title of a computer software application which is executed by the computer processor 4 and/or 104 and which is stored in the computer memory 2 and/or 102.

The third image 2900 may further include a name 2904 (name of the active IBPoint), a name 2906 (description of IBPoint), text 2908, text 2910, and text and/or icons 2910, 2912, 2914, 2916, and 2918 that can be selected by touching a computer screen of the computer display 10 to trigger an IBAction. For example, selecting SMS 2914 triggers SMS (test messaging or the sending of an SMS text message, from the mobile device transmitter/receiver 6 to another mobile device by the mobile device computer processor 4) as in step 2310 in FIG. 23.

FIG. 30 shows a fourth image 3000 which the mobile device computer processor 4 and/or the server computer processor 104 may cause to appear on the mobile device computer display 10. The fourth image 3000 may include text or application title 3002, and map image 3004 which includes a plurality of town names and highway locations on the map image arranged to match the particular town's or highways's geographical location. The fourth image 3000 may also include a pop up box 3006 corresponding to IBPoints that have been found as a result of a search at step 1214 in FIG. 12 or more specifically in our case at step 1324 of FIG. 13, as these were examples of IBPoints coming from a Geo Filter (which may be part of computer software which is part of mobile device computer memory 2 and executed by mobile device computer processor 4 in 1204. In this case, only one IBPoint is found i.e. Shoprite 3006. The pop up box 3006 includes text and/or icons 3006a, 3006b, 3006c, and 3006d describing IBPoint 3006 The fourth image 3000 also includes field, text and/or icon 3008 to trigger an IBAction. For example, selecting “Take me there” or field 3008 triggers, in at least one embodiment, an external computer software application (computer software application to be executed, for example by mobile device computer processor 4 and/or server computer processor) for a global positioning system “GPS”) as in step 2304 in FIG. 23.

FIG. 31 shows a fifth image 3100 which the mobile device computer processor 4 and/or the server computer processor 104 may cause to appear on the mobile device computer display 10. The fifth image 3100 may include text and/or icons 3126 to configure settings of this IBContext. 3128 brings user back to the list of IBContext—FIG. 28. Fields 3130 and 3136 let user create new IBPoint to this IBContext. Field 3130 lets a user create IBPoint, through for example, a manual recording step 504, through a listing recording step 506 or an application ibPoint recording based step 508, shown in FIG. 5, which be done by a user through mobile device computer interactive device 8 (such as a computer touch screen of mobile device), and via mobile device computer processor 4 as programmed by computer software stored in mobile device computer memory 2. The field 3136 is a quick way to manually record the current location in computer memory 2 or computer memory 102, of for example, the mobile device 1 of FIG. 1A in manual recording step 504 of FIG. 5.

Selection of field 3132 by a user causes the computer processor 4 to start the IBBrowser as shown in FIG. 27, FIG. 29 and FIG. 30. This also corresponds to the step 1008 in FIG. 10 where the current IBContext—2826 is marked active by, for example, the mobile device computer processor 4, storing an indication that the current IBContext is active in computer memory 2 or computer memory 102.

The fifth image 3100 also includes text 3124 to indicate the name of the current IBContext. The fifth image 3100 also Includes a plurality of rows 3134 including first row 3134a. Each row of rows 3134 represents an IBPoint, along with its description. Each row of rows 3134 has an image e.g. star, such as image 3131a for row 3134a to visually indicate ibPoint and its type (Geo, Visual or App based. In at least one embodiment, the star, such as image 3131a, is just an indicator and does not trigger any action. Each row of rows 3134 has a description of the ibPoint, such as address 3133a (which is “County Road 617), which may be stored in computer memory 2 and/or computer memory 102. Clicking on each image on the right, such as image 3135a lets a user edit the properties of the given IBPoint, such as in this example the IBPoint corresponding to row 3134a, through the computer interactive device 8. Each IBPoint may have properties such as description such as 3133a for the IBPoint corresponding to row 3134a and may have what other properties like Coordinates, type or a reference image (as for Visual Points) as well as the collection of IBActions belonging to this IBPoint.

In one or more embodiments of the present invention, three data base tables may be provided and/or stored in mobile device computer memory 2 and/or server computer memory 102. Each of the three database tables can be a relational database which can be used with or may be a type of MySQL database. (SQL stands for “Structured Query Language” database, and MySQL is a relational management database system named after Michael Widenius daughter “My”). Each of the three database tables may alternatively be used with or may be a type of “Bigdata” data base, which is a highly scalable RDF/graph database capable of 10B+ edges on a single node or culsered deployment for very high throughput). The three database tables have been described and/or named in the present application as (1) IBContexts, (2) IBPoints and (3) IBActions and also may be called IBContextsTable, IBPointsTable and IBActionsTable, respectively.

In the “IBContextTable” or database, there are a plurality of rows provided or stored. Each row in the “IBContext Table” has stored therein in computer memory such as computer memory 2 and/or computer memory 102, an instance of IBContext. The “IBContext Table” contains ContextId (a unique identifier string) and Name (a description string). Additionally, the “IBContext Table” contains type (e.g. general purpose, shopping, personal, phonebook, social media etc), access (public, private or group), write permission (yes or no), trigger distance (distance within which the IBContext is active), temperature range (within which IBContext is active), time (calendar time within which IBContext is active). There can be other conditions too depending on which the context is triggered. FIG. 11 describes this.

In the “IBPointTable”, there are a plurality of rows, wherein each row has stored therein in computer memory 2 and/or 102, an instance of IBPoint. The “IBPoint Table” contains ContextId (context id of the context to which point belongs), PointId (unique point identifier string), name (title of the IBPoint), description (a longer description string), latitude, longitude and altitude of the point, referenceImage (tag or image used to identify the IBPoint if it is a visual IBPoint), type (whether it is a geographical, visual, both geographic—visual or application based filter. FIG. 12 enumerates different types).

In the “IBActionTable”, there are a plurality of rows, wherein each row has stored therein in computer memory 2 and/or 102, an instance of IBAction. The “IBActionTable” contains ContextId (context id to which the IBAction belongs), PointId (point ID of the point to which this action belongs), ActionId (a unique action identifier string), Label (textual description while displaying this action), type (whether the action is email, phone, sms, video, audio, another IBContext, website or notify another app or mobile payment. This is listed in FIG. 23), description string (this is the string that helps in the action. So for example Email to jp@world.com would be Email://jp@world.com. Similarly a description string showing http://www.world.com describes that action is to start this web site) and application context (an optional string that is passed as it is when passing to process the action. For example, if the action is to use a word processor e.g. open_office to open /user/1.doc with a customized heading—“from IBrush”, the description string would be app://open_office 1.doc and the application context would be ‘from Ibrush”. This string—application context—is up to the action processor to interpret).

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

1. An apparatus comprising:
a mobile device comprising
a mobile device computer memory;
a mobile device computer processor;
a mobile device computer display;
a mobile device computer interactive device;
a mobile device transmitter/receiver; and
a server computer comprising
a server computer memory; and
a server computer processor;
wherein the mobile device computer processor is programmed by a computer program stored in the mobile device computer memory to allow a user by use of the mobile device computer interactive device to store data concerning a plurality of context topics in the server computer memory via transmission by the mobile device transmitter/receiver to the server computer;
wherein the mobile device computer processor is programmed by a computer program stored in the mobile device computer memory to display information for all of the plurality of context topics on the mobile device computer display at the same time;
wherein the mobile device computer processor is programmed by a computer program stored in the mobile device computer memory to allow a user to store a plurality of sets of data in the server computer memory via transmission by the mobile device transmitter/receiver to the server computer, one set of data of the plurality of sets of data for each of the plurality of context topics, wherein each set of data includes information about a plurality of geographic locations; and
wherein the mobile device computer processor is programmed by a computer program stored in the mobile device computer memory to display information about each of the plurality of geographic locations for a first set of data of the plurality of sets of data for a first context topic of the plurality of context topics on the mobile device computer display, in response to selection of the first context topic of the plurality of context topics by use of the mobile device computer interactive device, without displaying information about any of the other sets of data of the plurality of sets of data.

2. The apparatus of claim 1 wherein
wherein the mobile device computer processor is programmed by a computer program stored in the mobile device computer memory to edit information about one or more of the plurality of geographic locations for the first set of data of the plurality of sets of data, by use of the mobile device computer interactive device.

3. The apparatus of claim 1 wherein
the mobile device computer processor is programmed by a computer program stored in the mobile device computer memory so that selecting information for each of the plurality of geographic locations causes defined actions to be executed by the mobile device computer processor for each geographic location, wherein instructions for the defined actions are stored as a computer program in the mobile device computer memory.

4. The apparatus of claim 1 wherein
the mobile device computer processor is programmed to set an indication of whether information concerning each geographic location is active, wherein when active, a user, permitted access to the information concerning each geographic location is allowed to view the information concerning each geographic location on the mobile device computer display.

5. The apparatus of claim 1 wherein
the information concerning each geographic location relates to a location at which the mobile device is at least at one time located.

6. The apparatus of claim 1 wherein
the information concerning each geographic location is retrieved from a public internet search service and then stored in the server computer memory.

7. The apparatus of claim 1 wherein the
information concerning each geographic location is supplied by a third party computer software application.

8. The apparatus of claim 1 wherein
the server computer memory includes first and second application programming interface computer software programs which are executed by the server computer processor;
wherein the first application programming interface computer software program is programmed to be executed by the server computer processor in response to a communication with the mobile device computer processor concerning storing of the plurality of data objects in the server computer memory;
wherein the second application programming interface computer software program is programmed to be executed by the server computer processor in response to a communication with the mobile device computer processor concerning retrieval of information concerning each geographic location from the server computer memory via the mobile device transmitter/receiver and display of information concerning each geographic location on the mobile device computer display.

9. The apparatus of claim 1 wherein
the server computer processor is programmed to alter a listing of geographical points stored in the server computer memory in response to a request from the mobile device computer processor.

10. The apparatus of claim 1 wherein
each geographic location of each of the plurality of sets of data is defined by coordinates.

11. A method comprising
using a mobile device computer processor to store data concerning a plurality of context topics in a server computer memory via transmission by the mobile device transmitter/receiver to the server computer;
using the mobile device computer processor to display information for all of the plurality of context topics on a mobile device computer display at the same time;
using the mobile device computer processor to store a plurality of sets of data in the server computer memory via transmission by the mobile device transmitter/receiver to the server computer, one set of data of the plurality of sets of data for each of the plurality of context topics, wherein each set of data includes information about a plurality of geographic locations; and
using mobile device computer processor to display information about each of the plurality of geographic locations for a first set of data of the plurality of sets of data for a first context topic of the plurality of context topics on the mobile device computer display, in response to selection of the first context topic of the plurality of context topics by use of the mobile device computer interactive device, without displaying information about any of the other sets of data of the plurality of sets of data.

12. The method of claim 11 wherein
using the mobile device computer processor to edit information about one or more of the plurality of geographic locations for the first set of data of the plurality of sets of data, by use of the mobile device computer interactive device.

13. The method of claim 11 wherein
the mobile device computer processor is programmed by a computer program stored in a mobile device computer memory so that selecting information for each of the plurality of geographic locations for the first set of data causes defined actions to be executed by the mobile device computer processor, wherein instructions for the defined actions are stored as a computer program in the mobile device computer memory.

14. The method of claim 11 wherein
the mobile device computer processor is programmed to set an indication of whether information concerning each geographic location is active, wherein when active, a user permitted access to the information concerning each geographic location is allowed to view the information concerning each geographic location on the mobile device computer display.

15. The method of claim 11 wherein
the information concerning each geographic location relates to a location at which the mobile device is at least at one time located.

16. The method of claim 11 wherein
the information concerning each geographic location is retrieved from a public internet search service and then stored in the server computer memory.

17. The method of claim 11 wherein the
information concerning each geographic location is supplied by a third party computer software application.

18. The method of claim 11 wherein
the server computer memory includes first and second application programming interface computer software programs which are executed by the server computer processor;
wherein the first application programming interface computer software program is programmed to be executed by the server computer processor in response to a communication with the mobile device computer processor concerning storing of the plurality of data objects in the server computer memory;
wherein the second application programming interface computer software program is programmed to be executed by the server computer processor in response to a communication with the mobile device computer processor concerning retrieval of information concerning each geographic location from the server computer memory via the mobile device transmitter/receiver and display of information concerning each geographic location on the mobile device computer display.

19. The method of claim 11 wherein
the server computer processor is programmed to alter a listing of geographical points stored in the server computer memory in response to a request from the mobile device computer processor.

20. The method of claim 11 wherein
each geographic location of each of the plurality of sets of data is defined by coordinates.

21. An apparatus comprising:
a mobile device comprising
a mobile device computer memory;
a mobile device computer processor;
a mobile device computer display;
a mobile device computer interactive device;
a mobile device transmitter/receiver; and
a server computer comprising
a server computer memory; and
a server computer processor;
wherein the mobile device computer processor is programmed by a computer program stored in the mobile device computer memory to allow a user by use of the mobile device computer interactive device to store data concerning a plurality of context topics in the server computer memory via transmission by the mobile device transmitter/receiver to the server computer;
wherein the mobile device computer processor is programmed by a computer program stored in the mobile device computer memory to display information on the mobile device computer display about context topics of the plurality of context topics for which a condition is satisfied, but not context topics for which the condition is not satisfied, at the same time;
wherein the mobile device computer processor is programmed by a computer program stored in the mobile device computer memory to allow a user to store a plurality of sets of data in the server computer memory via transmission by the mobile device transmitter/receiver to the server computer, one set of data of the plurality of sets of data for each of the plurality of context topics, wherein each set of data includes information about a plurality of geographical locations;
wherein the mobile device computer processor is programmed by a computer program stored in the mobile device computer memory to display information about each of the plurality of geographical locations for a first set of data of the plurality of sets of data for a first context topic of the plurality of context topics on the mobile device computer display, in response to selection of the first context topic of the plurality of context topics by use of the mobile device computer interactive device, without displaying information about any of the other sets of data of the plurality of sets of data.

22. The apparatus of claim 21 wherein
the condition relates to time.

23. The apparatus of claim 21 wherein
the condition relates to temperature.

24. The apparatus of claim 21 wherein
the condition relates to current bandwidth available to the mobile device.
